(19) United States
(12) Patent Application Publication
(10) Pub. No.: US 2010/0299309 A1
(43) Pub. Date: Nov. 25, 2010

(54) BACKUP MANAGEMENT METHOD

(75) Inventors: Nobuhiro Maki, Yokohama (JP); Hironori Emaru, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/500,336

(22) Filed: Jul. 9, 2009

(30) Foreign Application Priority Data
May 21, 2009 (JP) 2009-122650

(51) Int. Cl. G06F 12/16; G06F 12/00

(52) U.S. Cl. 707/640; 711/162; 718/1; 711/E12.001; 711/E12.103; 707/822

(57) ABSTRACT

Restoration of all virtual machines are managed in respect of each restoration time thereof in a case where virtual machines at certain time in the past are restored under a server virtualization environment in which a plurality of virtual machines are constituted. A host computer creates a first snapshot of a first virtual machine at a first time specified by a management computer, and stores the first snapshot in a first logical volume of a storage device. Next, the storage system replicates in a second logical volume the first logical volume. In a case where the host computer creates a second snapshot of a second virtual machine at a second time that is before the first time and stores the second snapshot in the first logical volume, the management computer manages or displays the second snapshot creation time and snapshot information in association with the first snapshot creation time and snapshot information, respectively.

### CROSS-REFERENCE TO RELATED APPLICATIONS

This application relates to and claims priority from Japanese Patent Application No. 2009-122650 filed on May 21, 2009, the entire disclosure of which is incorporated herein by reference.

### BACKGROUND OF THE INVENTION

1. Field of the Invention

The present invention relates to backup and recovery using a storage system in a server virtualization environment.

2. Description of the Related Art

IT technology has come into widespread use in recent years, and host computers and other such IT technology itself has exhibited explosive growth. This has been making it difficult to manage the IT equipment due to the large numbers of such IT equipment involved. Server virtualization technology facilitates host computer management. Server virtualization technology, for example, is software-based technology in which a special virtualization program is run on a real host computer, and this virtualization program constructs on top of the real host computer a virtual machine (called either a virtual machine or a VM (Virtual Machine)) having a configuration, number of components and processing capabilities that differ from the real host computer. In accordance with the above-mentioned technology, an IT administrator is able to carry out management by utilizing only that portion of the computational capacity required without being concerned about the configuration, number of components or processing capabilities.

Meanwhile, in an environment that uses server virtualization (called the server virtualization environment), VM information as well as the OS and application software running on the VM and the data related thereto is collectively made into data (This is called a VM file. However, there is no need for this file to be a data structure that is managed by a file system; it may simply be data.) and this data is stored in a storage area such as a storage system. A backup in a server virtualization environment collectively stores operating VM. US Patent No. 2007244938 is one example of backup technology in a server virtualization environment. According to US Patent No. 2007244938, in a server virtualization environment, the virtualization program does quiescence does quiescence a VM that is in operation, stores this quiescent VM in the above-mentioned shared storage area, in which a VM shot file is stored as a file, as data (This is called a snapshot file. However, there is no need for this file to be a data structure that is managed by a file system; it may simply be data.). In general, the above-mentioned process for making the VM into a file is called a snapshot process. Generally speaking, a snapshot file comprises a VM virtual memory, a register content, and difference data written to the storage system subsequent to implementing a snapshot process, which are not stored in a VM file. Using the snapshot file and the VM file, the virtualization program is able to restore the VM at the point in time of snapshot acquisition when a logical failure occurs in the VM or in the OS or application running on the VM.

There is also storage system-based backup technology. For example, U.S. Pat. No. 7,120,769 discloses such technology. According to U.S. Pat. No. 7,120,769, in an environment in which a host computer is connected to a storage system, the storage system collects together volumes in which application program data is stored, and, using the storage system copy function, simultaneously replicates these volumes at a time when the application software running on the host computer is recoverable. Consequently, it is possible to recover application software information from both a logical failure of the application software and a physical failure, such as a disk device malfunction in the storage system. Storage system-based backup technology makes it possible to lessen the load on the host computer since the storage system performs the data copy required in the backup.

In a case where a virtualization program stores a VM file and snapshot file in a storage area of the storage system (for example, in one or more volumes or a range of block addresses established inside a volume), one or more VM files and snapshot files are intermixed and stored in this storage area. By contrast, the storage system carries out a backup process by specifying a VM file in volume units or a block address range, or an independent volume or block address range of a snapshot file data structure. For this reason, the backup of a VM specified by the storage system (that is, the storage of a VM file and snapshot file of a specified VM) also collectively backs up the other VM information that is mixed in.

However, the technologies disclosed in US Patent No. 2007244938 and U.S. Pat. No. 7,120,769 are not able to make efficient use of the backup data in a state in which a plurality of VM information (VM file, snapshot file) is intermixed in the storage area that receives the instruction to use such a storage device as the backup target.

### SUMMARY OF THE INVENTION

An object of the present invention is to provide an information processing system, a management computer, a method, a management program, a medium for storing the management program, and a program distribution server for installing the management program in the management computer, which make it possible to efficiently apply a VM backup.

To achieve the above-mentioned object, the present invention adopts the following configuration. The computer system of the present invention is configured from a management computer, a host computer that provides a plurality of virtual machines, and a storage system that provides a storage area to the host computer. The above-mentioned storage area stores a plurality of VM files and snapshot files corresponding to the above-mentioned plurality of virtual machines. The host computer does quiescence a first virtual machine, which is one of the above-mentioned plurality of virtual machines, and creates a first snapshot file corresponding to the above-mentioned first virtual machine in the above-mentioned storage area. The storage system creates a replication of the above-mentioned storage area after creating the first snapshot file in line with the above-mentioned quiescent. The above-mentioned management computer manages and displays the quiescent time of the above-mentioned first snapshot file and at least one snapshot file other than the above-mentioned first snapshot file with respect to a plurality of snapshot files stored in the created replication.

### BRIEF DESCRIPTION OF THE DRAWINGS

FIG. 1 is a block diagram related to the configuration of the computer system of a first embodiment of the present invention;

FIG. 2 is a detailed diagram of a management computer 100 in the first embodiment of the present invention;

FIG. 3 is a detailed diagram of a host computer 200 in the first embodiment of the present invention;

FIG. 4 shows storage information 1104 that is stored in the management computer 100 of the first embodiment of the present invention;

FIG. 5 shows copy configuration information 1103 that is stored in the management computer 100 of the first embodiment of the present invention;

FIG. 6 shows VM information 1106 that is stored in the management computer 100 of the first embodiment of the present invention;

FIG. 7 shows host information 1108 that is stored in the management computer 100 of the first embodiment of the present invention;

FIG. 8 shows volume pool information 1109 that is stored in the management computer 100 of the first embodiment of the present invention;

FIG. 9 shows backup catalog information 1105 that is stored in the management computer 100 of the first embodiment of the present invention;

FIG. 10 shows copy group utilization information 1101 that is stored in the management computer 100 of the first embodiment of the present invention;

FIG. 11 shows backup definition information 1110 that is stored in the management computer 100 of the first embodiment of the present invention;

FIG. 12 shows copy-pair management information 1210 that is stored in the storage system 300 of the first embodiment of the present invention;

FIG. 13 shows volume management information 1250 that is stored in the storage system 300 of the first embodiment of the present invention;

FIG. 14 is a conceptual diagram illustrating the concept of a VM backup in the first embodiment of the present invention;

FIG. 15 is a schematic diagram showing a VM backup operation of the first embodiment of the present invention;

FIG. 16 shows details of information included in an I/O request for the storage system of the first embodiment of the present invention;

FIG. 17 is the flow of processing of a storage discovery by the management computer of the first embodiment of the present invention;

FIG. 18 is the flow of processing of a host discovery by the management computer of the first embodiment of the present invention;

FIG. 19 is the flow of operations of a schedule definition by the management computer of the first embodiment of the present invention;

FIG. 20 is an example of a backup schedule input screen in accordance with the management computer of the first embodiment of the present invention;

FIG. 21 is the detailed flow of processing of a copy definition created by the management computer of the first embodiment of the present invention;

FIG. 22 is the flow of operations of a VM backup acquisition by the management computer of the first embodiment of the present invention;

FIG. 23 is an example of a backup result screen in accordance with the management computer of the first embodiment of the present invention;

FIG. 24 is the flow of processing of a restore operation by the management computer of the first embodiment of the present invention;

FIG. 25 is an example of an input screen for VM restore steps in accordance with the management computer of the first embodiment of the present invention;

FIG. 26 is a flowchart of a copy process by the storage system of the first embodiment of the present invention;

FIG. 27 is a conceptual diagram illustrating the concept of a VM backup in a second embodiment of the present invention;

FIG. 28 is an example of a backup schedule input screen in accordance with the management computer of the second embodiment of the present invention;

FIG. 29 is a detailed diagram of the management computer 100 of the second embodiment of the present invention;

FIG. 30 shows RPO information that is stored in the management computer 100 of the second embodiment of the present invention;

FIG. 31 is the operational flow of a VM backup acquisition in accordance with the management computer 100 of the second embodiment of the present invention;

FIG. 32 shows backup catalog information 1105 that is stored in the management computer 100 of the second embodiment of the present invention; and

FIG. 33 is an operational flow for a storage system-based copy process in accordance with the management computer 100 of the second embodiment of the present invention.

### DESCRIPTION OF THE PREFERRED EMBODIMENTS

The present invention will be explained below by referring to the drawings.

In the following explanation, the information of the present invention will be explained using expressions such as “xxx table”, “xxx list”, “xxx DB” or “xxx queue”, but this information may also be expressed in terms other than data structures such as a table, list, DB or queue. For this reason, in order to show that there is no reliance on data structures, “xxx table”, “xxx list”, “xxx DB” and “xxx queue” may also be called “xxx information”.

When explaining the content of the respective information, the expressions “identifying information”, “identifier”, “name”, “ID” and “number” will be used, but since these expressions are not limited to physical entities such as devices and components, but rather are also assigned to logical entities for the sake of making a distinction, these expressions are interchangeable.

In the below explanation, there are instances in which “program” is used as the subject in carrying out the explanation, but because a process stipulated in accordance with a program being executed on a processor is performed while using a memory and interface, the explanation may also be given by making the processor the subject. Further, a process that has been described having the program as the subject may also be a process that is performed by a management server or other such computer or information processing device. Either all or a portion of a program may be realized in accordance with dedicated hardware.

The various types of programs may be installed in the respective computers in accordance with a program distribution server or storage media.

### Embodiment 1

### (1-1) System Configuration

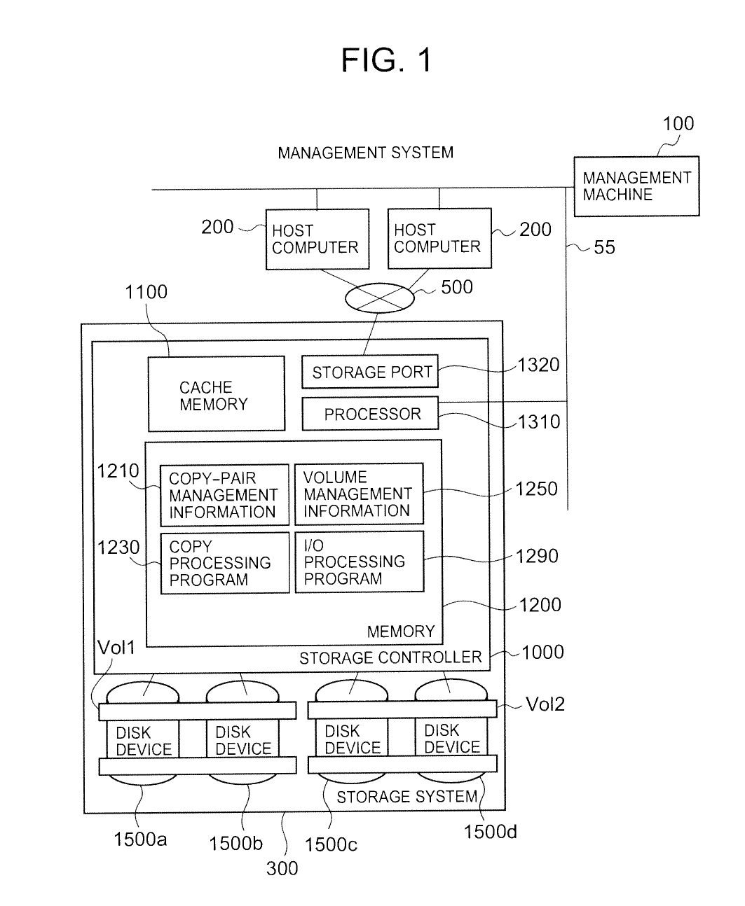

FIG. 1 is an example of a block diagram related to the configuration of the computer system of the first embodiment of the present invention.

The computer system is configured from a management computer 100; a host computer 200; and a storage system 300. Further, one unit each of the management computer 100, host computer 200, and storage system 300 are shown in the drawing, but a number of units of each may also be provided. In FIG. 1, the storage system 300 is shown as a single device, but if the storage system 300 is configured from more than one storage controller and a plurality of storage media (disk devices) for receiving a request from the host computer, the storage system 300 may also be configured from a plurality of devices (for example, virtual machines or copying devices).

The management computer 100, the host computer 200 and the storage system 300 are interconnected via a data communication line 500. The data communication line 500 may also be configured from one or more networks. The data communication line 500 may also be a communication line that shares either one or both of the data communication line 500 and a control communication line 55.

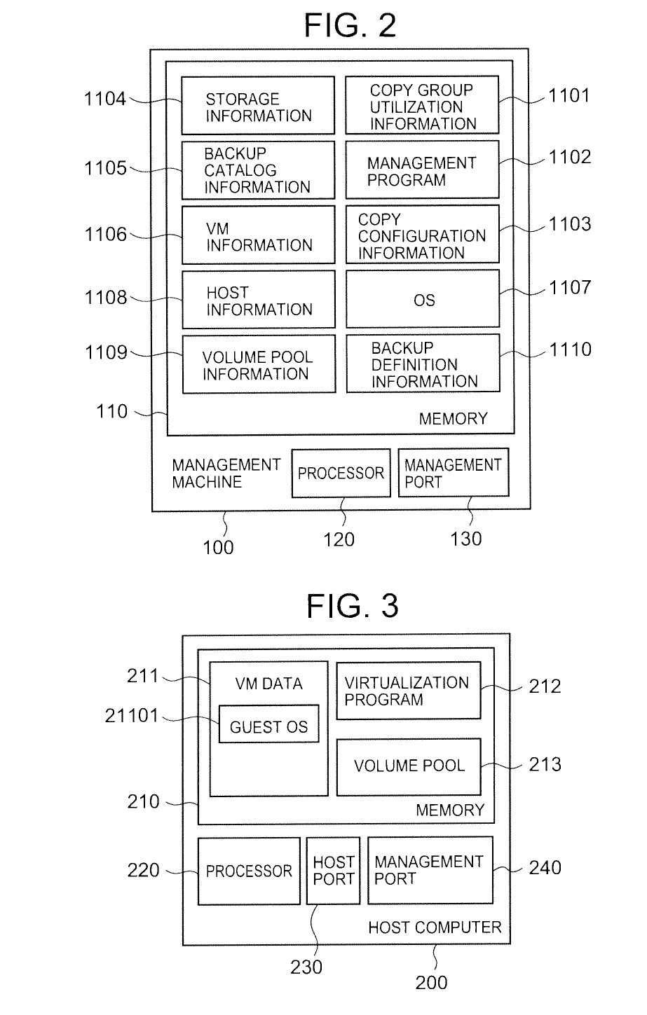

FIG. 2 shows the details of the management computer 100. The management computer 100 comprises a memory 110; a processor 120; and a management port 130. The memory 110, the processor 120 and the management port 130 are interconnected via an internal network (omitted from the drawing). Furthermore, the management computer may also be connected to the storage system 300 using a port other than the management port 130.

The processor 120 performs various processing by executing programs stored in the memory 110. For example, the processor 120 controls a local copy executed by the storage system 300 by sending an I/O request to this storage system 300. Furthermore, an I/O request comprises a write request, a read request or a copy control request.

The memory 110 stores a program executed by the processor 120, and information required by the processor 120. Specifically, the memory 110 stores copy group utilization information 1101; a management program 1102; copy configuration information 1103; storage information 1104; backup catalog information 1105; VM information 1106; host information 1108; volume pool information 1109; and backup definition information 1110. In addition, the memory 110 also stores an OS (Operating System) 1107. The OS 1107 is a program for controlling all the processing of the management computer 100.

The management program 1102 is for managing the storage system 300 connected to this management computer 100 via the data communication line 500.

The copy configuration information 1103 is for managing the configuration and status of a copy executed by the storage system 300. Furthermore, details of the copy configuration information 1103 will be explained using FIG. 5, which will be described hereinbelow.

The copy group utilization information 1101 is for managing a copy that is in operation, and backup utilization propriety.

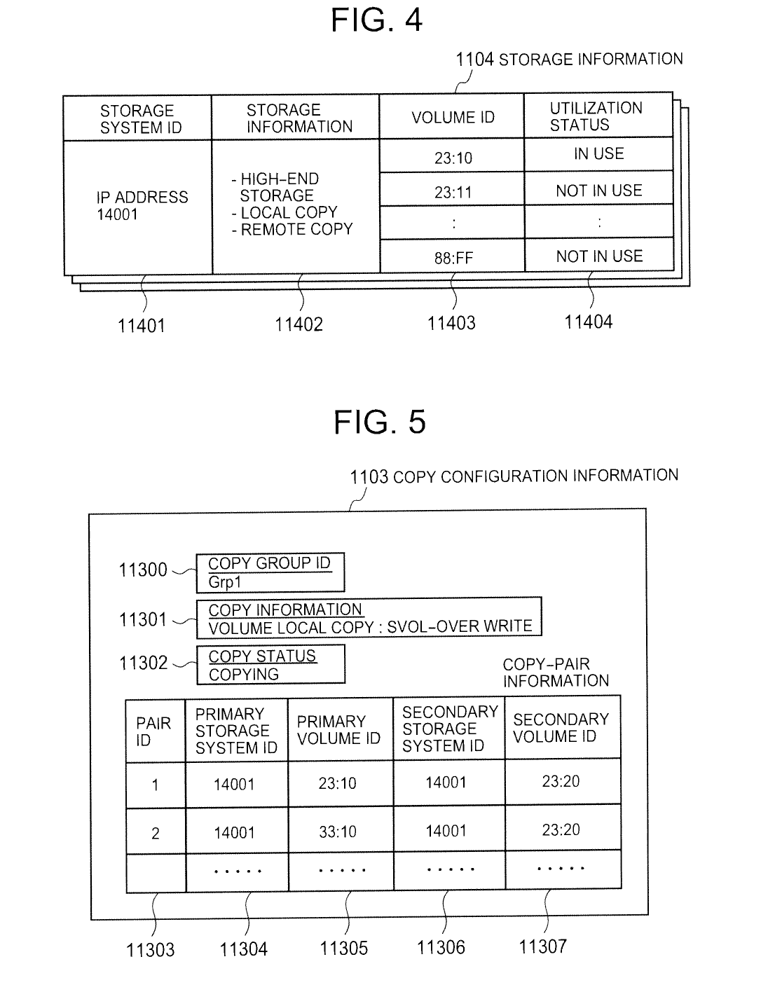

The storage information 1104 is management information related to the storage system 300 that is managed by this management computer 100. One piece of storage information 1104 is created for one storage system 300. Details concerning the storage information 1104 will be explained using FIG. 4, which will be described hereinbelow.

The backup catalog information 1105 is for managing a backup-targeted VM and a backup time. Details concerning the backup catalog information 1105 will be explained using FIG. 9, which will be described hereinbelow.

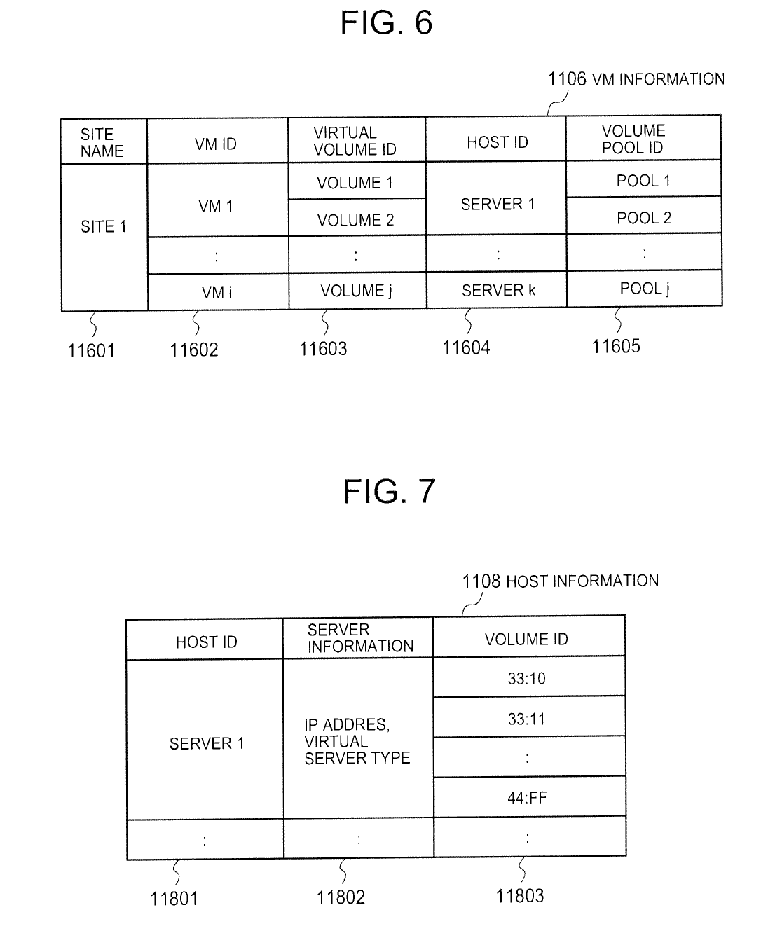

The VM information 1106 is management information for maintaining detailed information on a VM, which is a backup candidate. Details concerning the VM information 1106 will be explained using FIG. 6, which will be described hereinbelow.

The host information 1108 is management information for maintaining detailed information on the host computer 200 that is running a VM that is a backup candidate. Details concerning the host information 1108 will be explained using FIG. 7, which will be described hereinbelow.

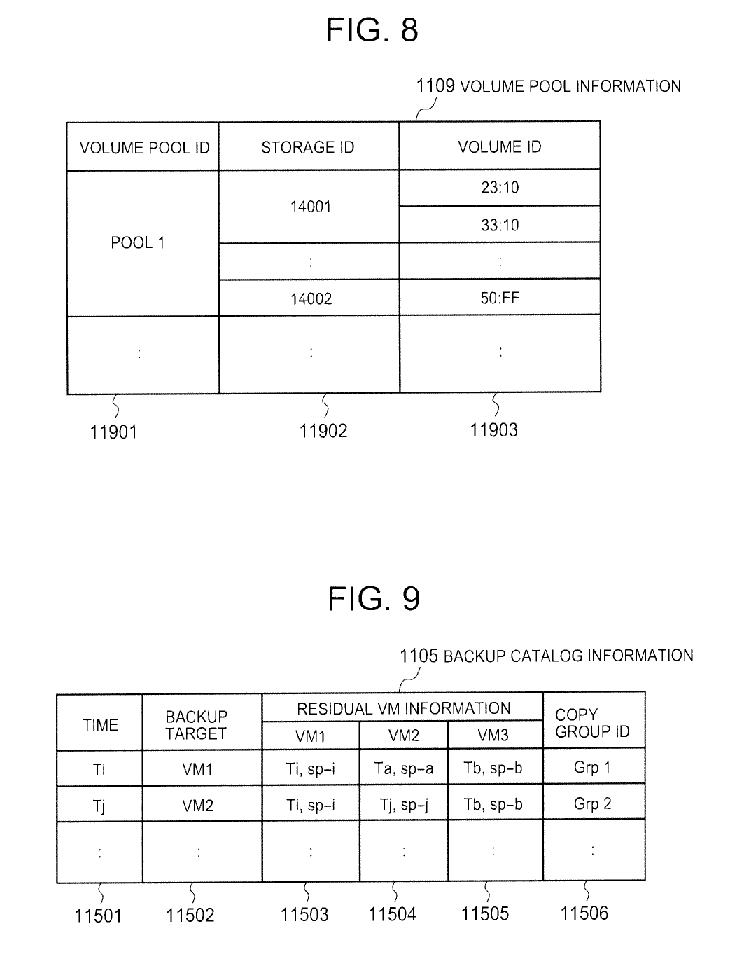

The volume pool information 1109 is management information of a storage pool comprising a plurality of storage areas for managing host computer maintenance of VM information. Details concerning the volume pool information 1109 will be explained using FIG. 8, which will be described hereinbelow.

The backup definition information 1110 is management information set at backup definition time.

Details concerning the backup definition information 1110 will be explained using FIG. 11, which will be described hereinbelow.

Furthermore, the management computer 100 may also have an input/output device. Examples of input/output devices include a display, a keyboard and a pointer device, but the input/output device may also be a device other than these. Instead of an input/output device, a serial interface or an Ethernet® interface may serve as the input/output device, and a display machine, which has either a display, a keyboard or a pointer device, may be connected to this interface, and by sending information for display to the display machine and receiving input information from the display machine, the display machine may be used to carry out displays and to receive input instead of the input/output device.

Hereinafter, a cluster of more than one computer, which manages the host computer and the storage system, and displays the display information of the invention of the application may be called the management system. In a case where the management computer displays the display information, the management computer is the management system, and a combination of a management computer and a display machine is also a management system. Further, to speed up management processing and make this processing more reliable, a plurality of machines may realize processing at the same time as the management computer, in which case, this plurality of machines (also includes the display machine when the display machine carries out displays) is the management system.

FIG. 3 shows the details of the host computer 200. The host computer 200 comprises a memory 210; a processor 220; a host port 230; and a management port 240. The memory 210, the processor 220, the host port 230 and the management port 240 are interconnected via an internal network (omitted from the drawing). Furthermore, in the invention of this application, the host computer comprises a management port for communicating with the management computer, and a host port for inputting/outputting data to/from the storage system, but a single port may also be used in a shared manner.

The processor 220 performs various processing by executing a program stored in the memory 210. For example, by sending an I/O request to the storage system 300, the processor 220 accesses one or more logical volumes (may simply be called volumes hereinafter) Vol1, Vol2 (shown in FIG. 1) provided by this storage system 300.

The memory 210 stores a program executed by the processor 220, and the data and so forth required by the processor 220. Specifically, the memory 210 stores a virtualization program 212 and a VM 211.

The virtualization program 212 is for virtualizing the host computer 200 and creating a virtual machine VM 211.

The volume pool 213 is management information for grouping together a plurality of logical volumes provided by the storage system 300, and for corresponding a logical volume and a virtual volume that are used by the virtualization program 212, which provides the virtual volume (VVol) for the VM.

VM data 211 is for maintaining the information of the VM used by the virtualization program 212. In addition to a VM configuration (the type of processor of the virtual machine, the main memory, the number of registers, the capacity of the virtual volume, and so forth), the VM data 211 comprises the status of the virtual processor that is virtually running on the VM, operating information such as temporary data (the status, main memory and register contents of the virtual machine), and data such as the OS (called a guest OS) 21101 and the application software running on the VM in the contents of the above-mentioned main memory.

The host port 230 is an interface that is connected to the storage system 300 via the data communication line 500. Specifically, the host port 230 sends an I/O request to the storage system 300.

The management port 240 is an interface for communicating with the management computer 100. Furthermore, the host computer 200 may also have an input/output device. Examples of input/output devices include a display, a keyboard and a pointer device, but the input/output device may also be a device other than these. Instead of an input/output device, a serial interface or an Ethernet interface may serve as the input/output device, and a display machine, which has either a display, a keyboard or a pointer device, may be connected to this interface, and by sending information for display to the display machine and receiving input information from the display machine, the display machine may be used to carry out displays and to receive input instead of the input/output device. The respective input/output devices of the host computer 200 and the management computer 100 do not have to be the same. The management port 240 may also substitute as another port of the host computer 200.

Next, the storage system 300 shown in FIG. 1 will be explained.

The storage system 300 comprises a storage controller 1000; and a disk device 1500.

Furthermore, the data communication line 500 may be configured from one or more networks. In addition, the data communication line 500 may also be a communication line or a network that shares either one or both of the data communication line 500 and a control communication line 55.

The disk device 1500 is a disk-type storage media drive, and stores data that has been write-requested from the host computer 200. Instead of the disk device 1500, another type of storage device (for example, a flash memory type) may also be used. The storage controller 1000 controls the entire storage system 300. Specifically, the storage controller 1000 controls the writing of data to the disk device 1500, and also controls the reading of data from the disk device 1500. The storage controller 1000 also provides the storage area of the disk device 1500 to the host computer 200 as one or more logical volumes. Furthermore, there may be a plurality of the disk devices. FIG. 1 shows an example in which logical volumes Vol1, Vol2 based on different disk devices 1500a, 1500b, 1500c, 1500d are provided to the host computer 200.

The storage controller 1000 comprises a memory 1200; a cache memory 1100 (may also be combined with the memory 1200); a storage port 1320; and a processor 1310. Furthermore, in packaging the storage controller 1000, one or more of each of the above-mentioned hardware components (for example, the storage port 1320 and the processor 1310) may exist on one or more circuit boards. For example, in order to enhance reliability and heighten performance, the storage controller 1000 may be configured from a plurality of control units, and each control unit may have a memory 1200, a storage port 1320, a processor 1310, and in addition, the hardware configuration may also be such that the cache memory 1100 is connected to a plurality of control units. Although omitted from the drawing, the storage controller 1000 has one or more backend ports, and the backend port is connected to the disk device 1500. However, the storage controller 1000 may also be connected to the disk device via hardware other than the backend port.

The cache memory 1100 temporarily stores data to be written to the disk device 1500, and data read out from the disk device 1500.

The storage port 1320 is an interface that is connected to the host computer 200 and the other storage system 300 by way of the data communication line 500. The storage port 1320 may also be connected to the management computer 100. Specifically, the storage port 1320 receives an I/O request (examples of which being a read request and/or a write request) from the host computer 200. Further, the storage port 1320 sends data read out from the disk device 1500 to the host computer 200. In addition, when implementing a remote copy, the storage port 1320 sends and receives the data being exchanged between the storage systems 300.

The processor 1310 performs various processing in accordance with executing programs stored in the memory 1200. Specifically, the processor 1310 process an I/O request received in accordance with the storage port 1320. The processor 1310 also controls the writing of data to the disk device 1500 and the reading of data from the disk device 1500. The processor 1310, in accordance with processing the program shown hereinbelow, sets a logical volume based on one of more disk device 1500 storage areas.

The memory 1200 stores programs executed by the processor 1310 and the data required by the processor 1310. Specifically, copy-pair management information 1210, a copy processing program 1230, volume management information 1250 and an I/O processing program 1290 are stored in the memory 1200.

Next, the programs and information stored in the memory 1200 will be explained.

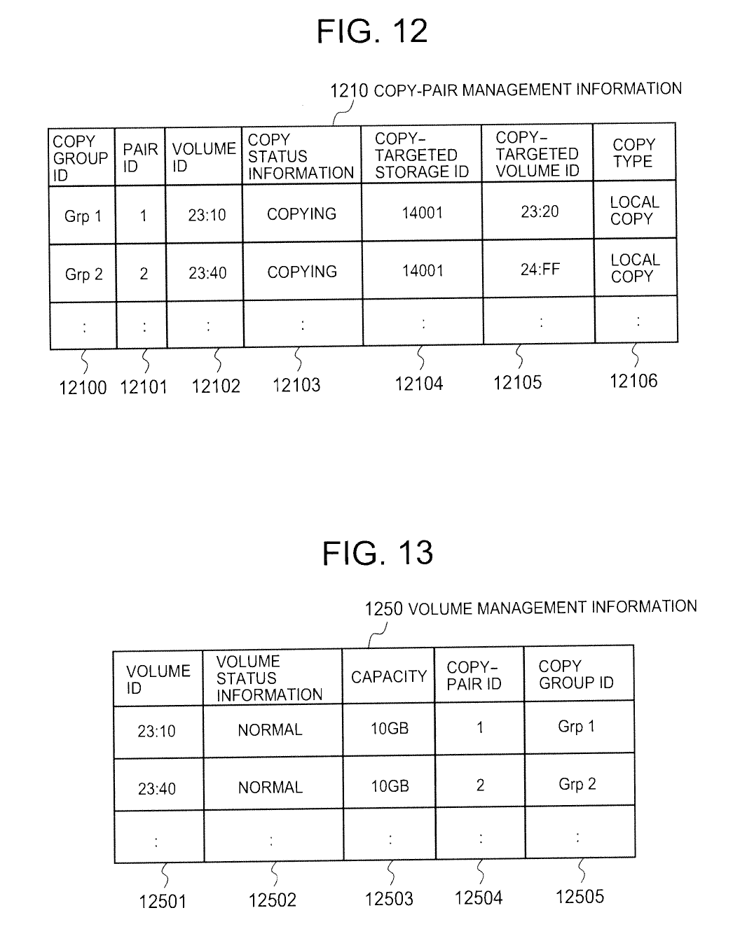

The copy-pair management information 1210 is for managing a copy pair. The copy pair is a set of two logical volumes in a storage system 300 that are targeted for a copy. Details concerning the copy-pair management information 1210 will be explained using FIG. 12, which will be described further below.

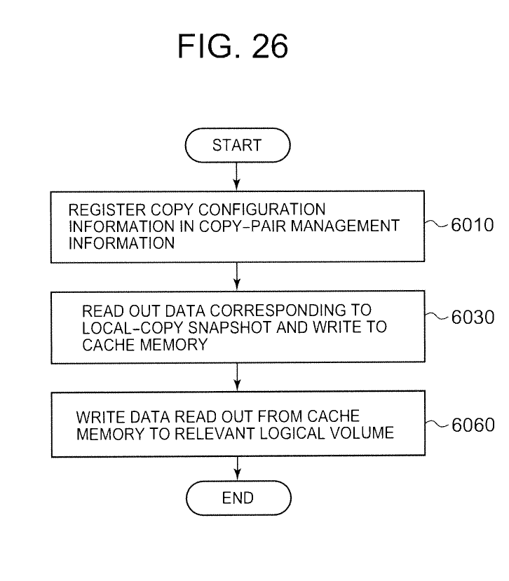

The copy processing program 1230 performs a replication process. Copy processing will be explained using FIG. 26, which will be described further below.

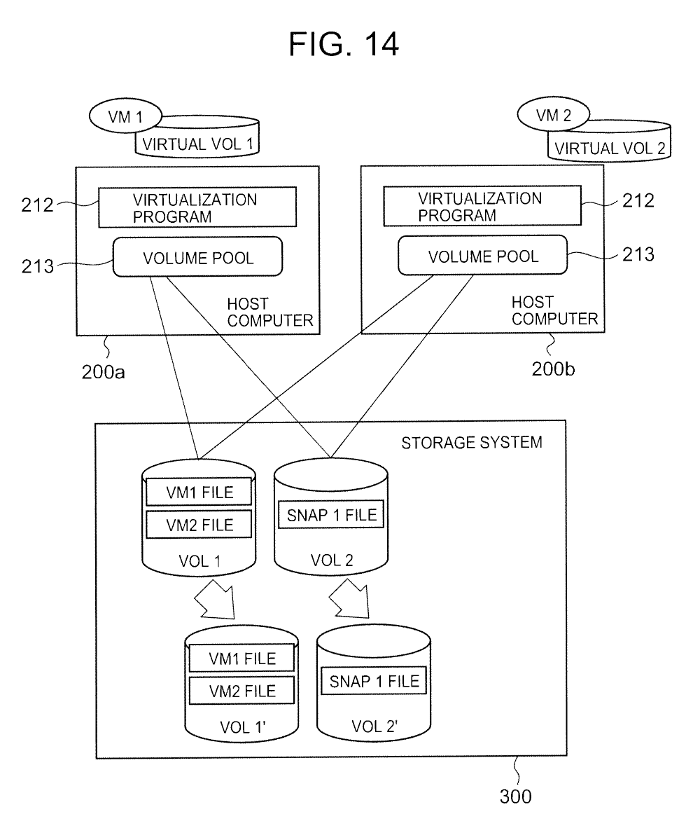

The volume management information 1250 comprises information for managing the logical volume provided by the storage system 300. The volume management information 1250 will be explained in detail using FIG. 13, which will be described further below.

According to the configuration explained hereinabove, write data sent by the host computer 200 is stored in the logical volume of the storage system 300, and this write data is replicated and stored in a different logical volume inside the same storage system 300 in accordance with a volume local copy.

Consequently, it is possible to duplicate the data, which is in the logical volume inside the storage system 300 and is targeted for data duplexing, as a result of which, in a case where the data of the replication-source logical volume (primary logical volume) of the storage system is lost, it is possible to use the replicated data stored in the replication-destination logical volume (secondary logical volume) to restore the pre-loss processing.

Furthermore, the primary logical volume and the secondary logical volume may reside inside a single device, and, as in a remote replication, may reside in different devices (for example, a case in which the primary logical volume is in a first storage system, and the secondary logical volume is in a second storage system). A copy process does not necessarily always have to copy all of the data of the primary logical volume from the disk device corresponding to the primary logical volume to the disk device corresponding to the secondary logical volume, and any copy process may be used as long as the secondary logical volume storing the replication of the data of the primary logical volume is able to be provided to the host computer at the time the copy request was received by the storage system. Such a copy process includes logical snapshot technology that utilizes a storage device-based Copy-On-Write algorithm.

In addition, in the above-mentioned example, the operation involves making one or more logical volumes the replication source, and receiving a request from a computer (for example, the host computer or the management computer) outside the storage system. However, if it is also possible to specify a storage area rather than specify a volume, a copy process may also be carried out for another specification and for the storage area that received the specification. As an example of this, there is a process which receives a request that specifies a logical volume and a range of block addresses inside the logical volume, and copies the data in this range of block addresses. Similarly, if the storage system receives a request that has a file as the target, a copy may also be performed by receiving the request that specifies either a file or a directory, and copying either the file or the directory.

### (1-2) Overview of Embodiment 1

An overview of the first embodiment will be explained next. In the first embodiment, an explanation was given of an example in which the snapshot function provided by the virtualization program 212 of the host computer 200 and the copy function provided by the storage system are combined in a server virtualization environment to realize a VM backup.

FIG. 14 is a conceptual diagram for illustrating the concept of the VM backup in the first embodiment.

The virtualization program 212 runs on the host computer 200. By running the virtualization program 212, the host computer is able to provide one or more VM to a client machine or a user that is using this host computer. The host computer 200 writes and reads to and from one or more logical volumes provided by the storage system 300. The host computer 200 provides a portion of the storage area of the accessed logical volume to the VM as a virtual volume, and writes a VM file to the logical volume. The VM file stores the configuration information of the VM included in the VM data 211 (such as the main memory size, number of registers, and virtual volume capacity of the virtual machine), and the data written to the virtual volume. The host computer 200 manages the corresponding relationship between the virtual volume and the logical volume as a logical entity (as information, the volume pool information 1109, which will be described further below) called a volume pool 213.

At VM backup, the host computer 200 creates a snapshot file from the VM in accordance with the contents of a virtualization program instruction, and writes the created snapshot file to any storage system 300 logical volume registered in the volume pool. The snapshot file is data comprising VM operation information managed by the VM data 211, and update information for the virtual volume to which the targeted VM was written subsequent to the creation of the snapshot file. By using this snapshot file and VM file in combination, the host computer 200 is able to reproduce the VM at the point in time of snapshot file creation and an arbitrary point in time.

Next, the data of all the logical volumes (copy-source logical volumes) registered in the volume pool to which the storage system 300 has written the snapshot file and VM file is replicated in a different logical volume (copy-destination logical volume) using the copy function.

At VM restore, the storage system 300 runs the copy function in the reverse direction of the copy direction, and writes the snapshot file, which was backed up to the copy-destination logical volume back, to the copy-source logical volume. Next, the host computer uses the written-back snapshot file to reboot the VM.

However, the VM restore method is not limited to the method described above, and if the VM can be booted anew using the snapshot file and the VM file stored in the copy-destination logical volume, the snapshot file may be stored anywhere, and, furthermore, the host computer, which is booting up the new VM, may be the same host computer that originally booted up the VM or a different one.

FIG. 14 shows the backup operation for VM1. The host computer 200a writes the snapshot file (Snap1 File) of VM1, which is running on this host computer 200a, to an arbitrary logical volume (Vol2 in the case of FIG. 14) registered in the volume pool. The storage system 300 replicates the data of the copy-source logical volumes (Vol1, Vol2) registered in the volume pool to the copy-destination logical volumes (Vol1′, Vol2′) inside the same storage system 300 using the copy function.

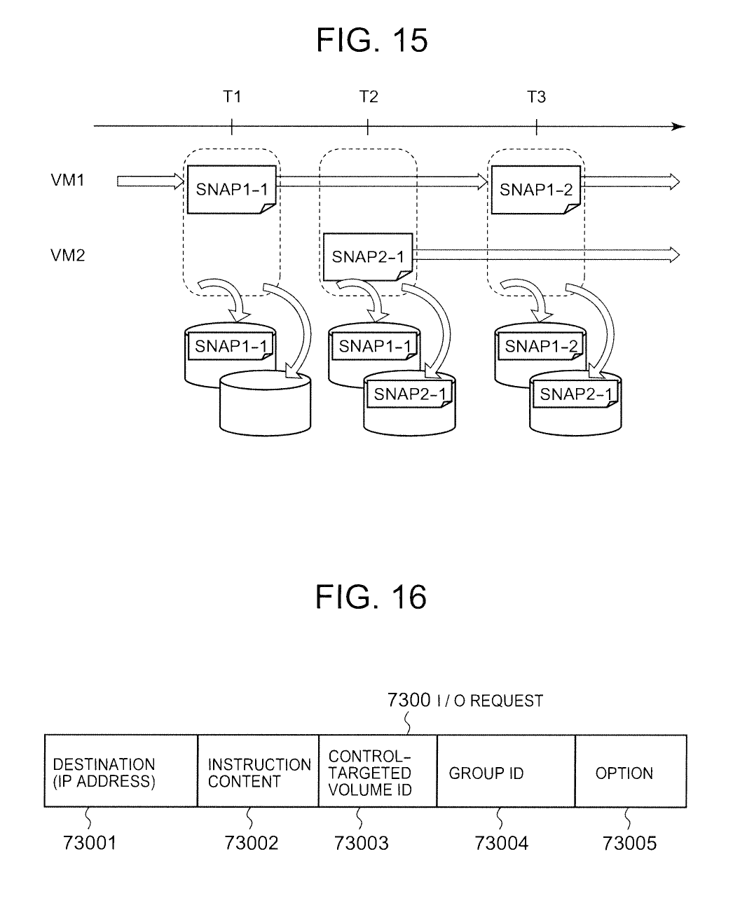

FIG. 15 is an example of a schematic diagram showing the VM backup operation. In FIG. 15, VM1 and VM2 are running on the host computer, and backups of VM1 are acquired at times T1, T3, and a backup of VM2 is acquired at time T2. Here, at the backup of VM1 at T1, a snapshot file (Snap1-1) is created by the host computer and backed up to the logical volume inside the storage system, and this snapshot file (Snap1-1) resides in the logical volume until time T3, which is the subsequent backup time of VM1. At time T3, the host computer deletes the existing snapshot, and creates a new snapshot. Next, the storage system uses the copy function to replicate all the data in this logical volume in the copy-destination logical volume inside the same storage system.

The backup at time T2 will be considered here. At time T2, the VM2 snapshot file (Snap2-1) is backed up, but the snapshot file (Snap1-1) created in the T1 backup is stored in the copy-source logical volume at the same time, and all the data is replicated in the copy-destination logical volume using the copy function.

Next, the recovery of the VM2 backup acquired at time T2 will be considered. If the storage system 300 implements backup recovery at time T2, it is actually possible to restore the VM1 snapshot file (Snap1-1) in addition to the VM2 snapshot file (Snap2-1). However, in restoring VM1, it is necessary to accurately manage which VM of which time is to be restored at time T2. Accordingly, in a case where a snapshot file of a VM other than this snapshot acquisition-targeted VM that was acquired previously exists at snapshot acquisition time T2, the backup information of the time (T1) previous to T2 by one time is stored in the backup catalog information 1105 as a portion of the T2 backup information. The backup catalog information 1105 will be explained in detail using FIG. 9, which will be described further below.

### (1-3) Storage Information

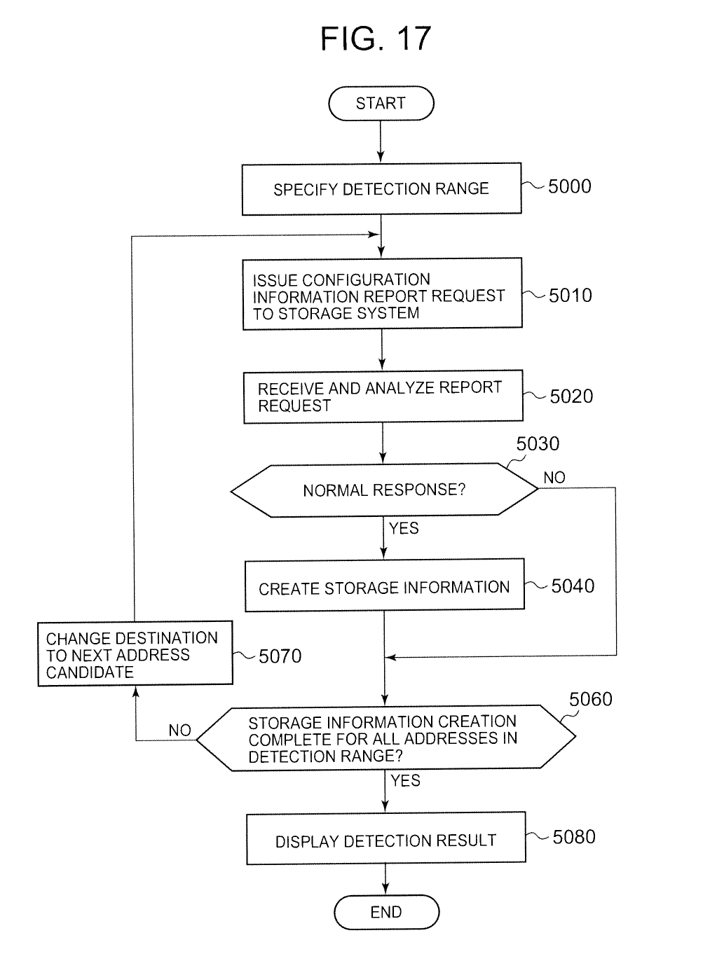

FIG. 4 is an example of a schematic diagram of the storage information 1104 stored in the management computer 100. The process for creating the storage information 1104 will be explained using FIG. 17, which will be described further below.

The storage information 1104 shows information about the storage system 300 and logical volume that the management computer 100 recognizes, and comprises a storage system ID 11401, storage information 11402, a volume ID 11403, and utilization status 11404.

The storage system ID 11401 is an identifier comprising a storage system 300 identifier and an address (IP address) managed by the management computer 100.

The storage information 11402 comprises information uniquely held by the storage system 300. The storage information 11402 has the storage system type (for example, high-end storage), and the storage system functions capable of being used (for example, local copy and remote copy).

The volume ID 11403 is the identifier of the logical volume that is allocated and managed inside the device of the storage system 300 for use in the internal processing of the storage system 300 denoted by the storage system ID 11401.

The utilization status 11404 is information denoting whether or not the logical volume of the relevant volume ID is being used by the host computer 200.

### (1-4) Copy Configuration Information

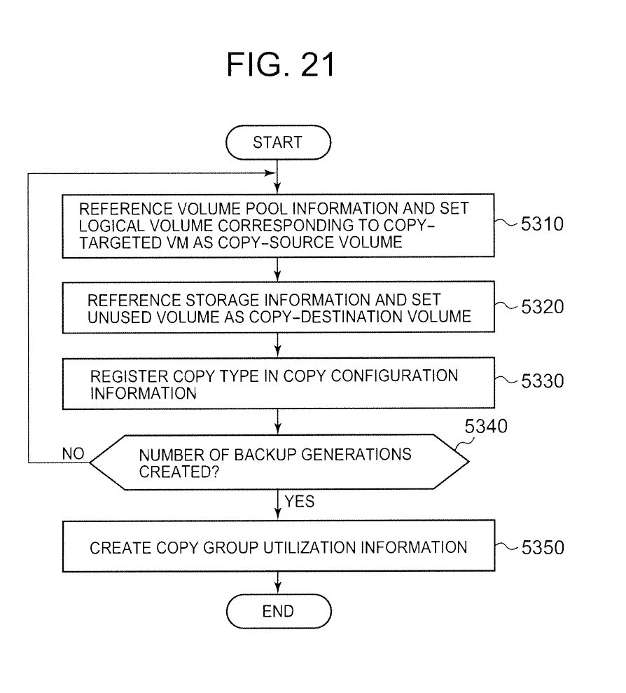

FIG. 5 is an example of a block diagram of the copy configuration information 1103 stored in the management computer 100. The process for creating the copy configuration information 1103 will be explained using FIG. 21.

The copy configuration information 1103 is created each time the management computer 100 uses the copy function, and a copy group ID 11300, which is the copy group identifier, is allocated to this information for each copy instruction. The copy configuration information 1103 comprises the copy group ID 11300, copy information 11301, a copy status 11302, and copy-pair information 11303 through 11307.

The copy information 11301 comprises a copy type and copy option information. The copy type denotes if the copy, which is a function provided by the storage system 300, is a local copy or a remote copy. A local copy is a copy performed inside the same storage system 300, and in accordance with this, the copy-source logical volume and the copy-destination logical volume exist inside the same storage system 300. A remote copy is a copy that is performed between different storage systems 300, and in accordance with this, the copy-source logical volume and the copy-destination logical volume exist inside different storage systems. The copy option information included in the copy information 11301 represents various copy type options. For example, the copy option information denotes whether or not it is possible to write to the secondary volume (copy-destination logical volume) during a local copy temporary suspension. The local copy temporary suspension is a temporary suspension of a local copy in accordance with an instruction from the management computer 100.

The copy status information 11302 shows the current status of the copy being managed by this copy configuration information 1103. Specifically, for example, the copy status information 11302 denotes the status of the copy being managed by this copy configuration information 1103 as being any of copying, temporary suspension, pair status or abnormal status.

The copy-pair information comprises a pair ID 11303, a primary storage system ID 11304, a primary volume ID 11305, a secondary storage system ID 11306 and a secondary volume ID 11307.

The pair ID 11303 is a sequential number, and manages the order in which copies are performed.

The primary storage system ID 11304 is the identifier of the storage system (hereinafter, the primary storage system) 300 that provides the copy-source logical volume. The primary storage system 300 directly stores data from the host computer 200 and the management computer 100.

The primary volume ID 11305 is the primary volume identifier assigned for allowing the primary storage system 300 to manage the primary volumes inside the devices.

The secondary storage system ID 11306 is the identifier of the secondary storage system 300 (hereinafter, secondary storage system) that provides the copy-destination logical volume. In the case of a local copy, this constitutes the same ID as that of the primary storage system 300.

The secondary volume ID 11307 is the secondary volume identifier assigned for allowing the secondary storage system 300 to manage the secondary volumes inside this system's devices.

### (1-5) VM Information

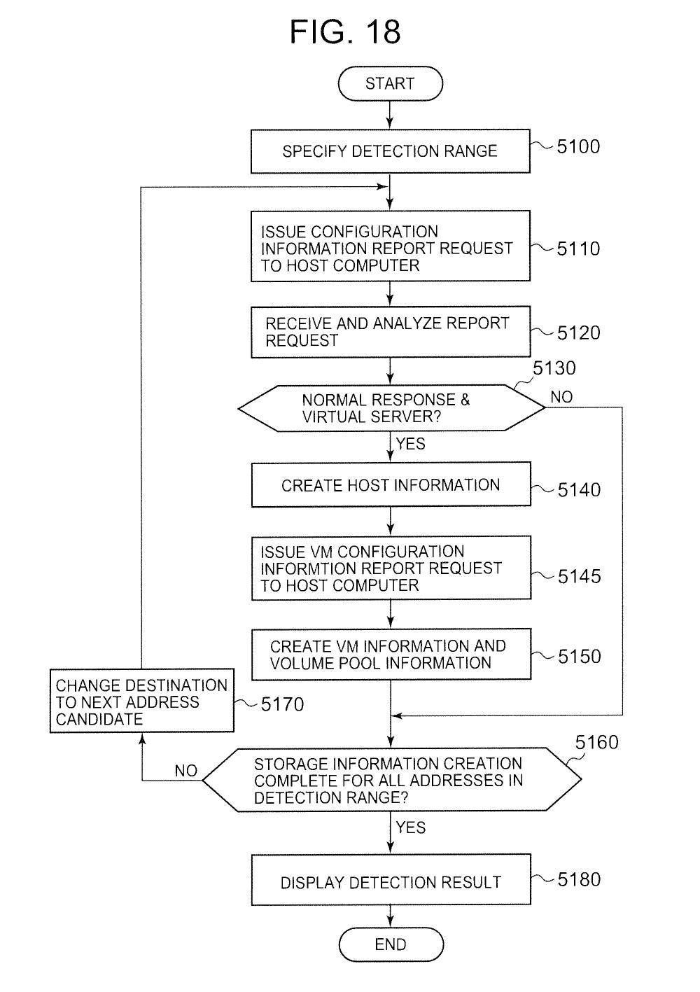

FIG. 6 is an example of a block diagram of the VM information 1106 stored in the management computer 100. The process for creating the VM information 1106 will be explained using FIG. 18.

The VM information 1106 comprises a site name 11601, a VM ID 11602, a virtual volume ID 11603, a host ID 11604 and a volume pool ID 11605.

The site name 11601 is a group identifier for collectively managing a plurality of VM.

The VM ID 11602 is a virtual machine identifier that runs on the host computer 200.

The virtual volume ID 11603 is a virtual volume identifier that the virtualization program provides to the VM.

The host ID 11604 is an identifier denoting the reference destination of host computer information registered in the host information 1108 shown in FIG. 7, which will be described below.

The volume pool ID 11605 is an identifier denoting the reference destination of a plurality of volume pool information registered in the volume pool information 1109 shown in FIG. 8, which will be described further below.

### (1-6) Host Information

FIG. 7 is an example of a block diagram of the host information 1108 stored in the management computer 100. The process for creating the host information 1108 will be explained using FIG. 18. The host information 1108 comprises a host ID 11801, server information 11802, and a volume ID 11803.

The host ID 11801 is an identifier comprising an identifier for allowing the management computer 100 to identify a host computer, and an address (IP address). The server information 11802 stores an IP address and the type of the virtual server program as a set of information that the management computer 100 needs to access the host computer. The volume ID 11803 is an identifier for identifying the logical volume of the storage system accessible by the host computer 200 denoted by the host ID 11801.

### (1-7) Volume Pool Information

FIG. 8 is an example of a block diagram of the volume pool information 1109 stored in the management computer 100. The process for creating the volume pool information 1109 will be explained using FIG. 18, which will be described further below.

The volume pool information 1109 comprises a volume pool ID 11901, a storage ID 11902, and a volume ID 11903.

The volume pool ID 11901 is the identifier of the volume pool used by the virtualization program 212 running on the host computer 200. Logical volumes provided by a plurality of storage systems are registered in this volume pool.

The storage ID 11902 is the identifier of the storage system registered in the volume pool.

The volume ID 11903 is an identifier for identifying the logical volume provided by the storage system registered in the volume pool.

### (1-8) Backup Catalog Information

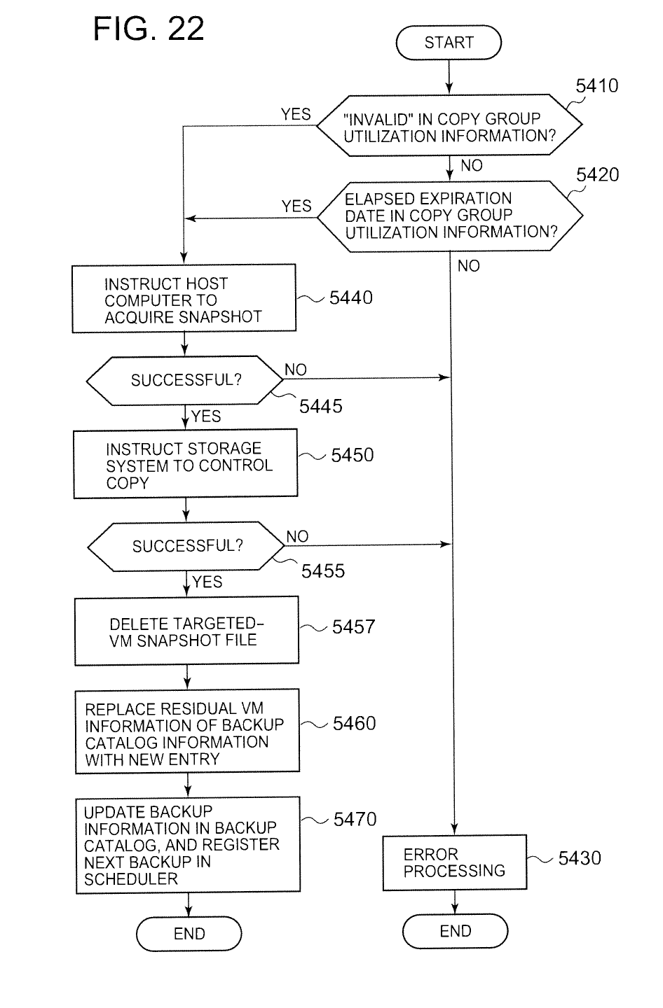

FIG. 9 is an example of a block diagram of the backup catalog information 1105 stored in the management computer 100. The process for creating the backup catalog information 1105 will be explained using FIG. 22, which will be described further below. The backup catalog information 1105 comprises a time 11501, a backup target 11502, residual VM information 11503 through 11505, and a copy group ID 11506.

The time 11501 is the backup implementation time. The backup implementation time is stored in this area.

The backup target 11502 stores the identifier of the VM that constitutes the backup target. The residual VM information 11503 through 11505 is information of all the snapshot files remaining in the logical volume registered in the volume pool. The snapshot file creation time and snapshot identifier are stored in this area.

The copy group ID 11506 is the copy group identifier used when the storage system 300 is utilizing the copy function.

### (1-9) Copy Group Utilization Information

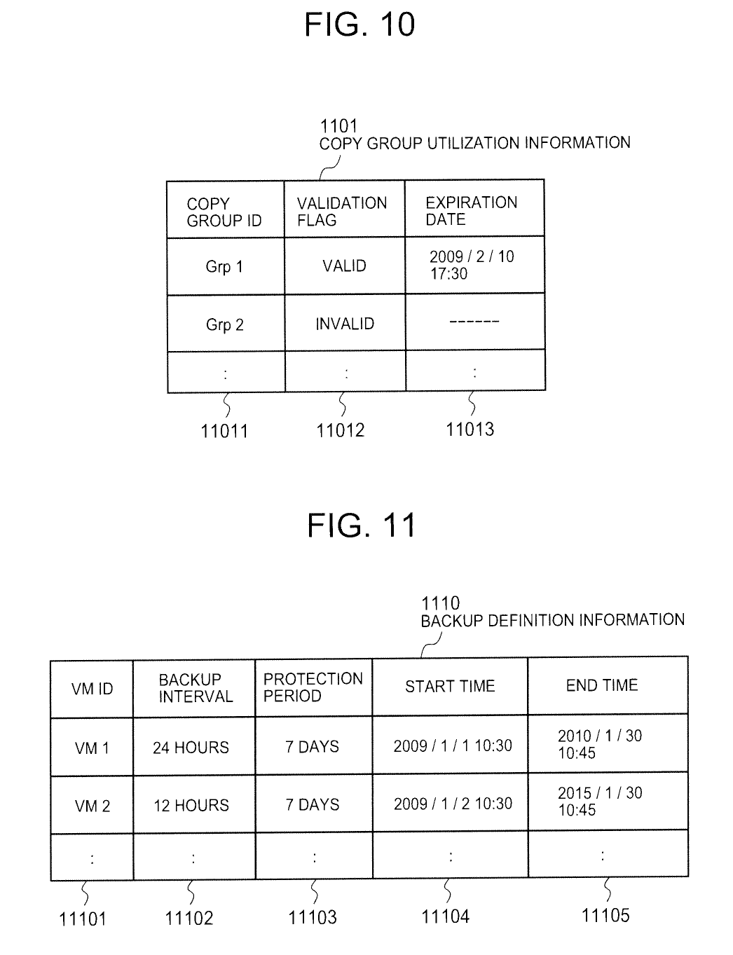

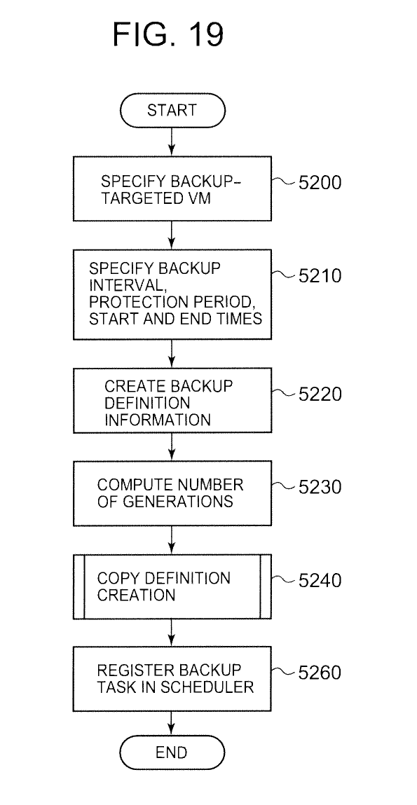

FIG. 10 is an example of a block diagram of the copy group utilization information 1101 stored in the management computer 100. The process for creating the copy group utilization information 1101 will be explained using FIG. 19.

The copy group utilization information 1101 comprises a copy group ID 11011, a validation flag 11012, and an expiration date 11013.

The copy group ID 11011 is the copy group identifier used when the storage system 300 is utilizing the copy function.

The validation flag 11012 denotes whether or not valid data exists in the copy-destination logical volume denoted by the copy group ID created by the management computer 100.

The expiration date 11013 denotes the expiration date of the copy group created by the management computer 100. A copy group which exceeds this expiration date may be used in a different backup.

### (1-10) Backup Definition Information

FIG. 11 is an example of a block diagram of the backup definition information 1110 stored in the management computer 100. The process for creating the backup definition information 1110 will be explained using FIG. 19, which will be described further below.

The backup definition information 1110 comprises a VM ID 11101, a backup interval 11102, a protection period 11103, a start time 11104 and an end time 11105.

The VM ID 11101 is the identifier of the VM running on the host computer 200.

The backup interval 11102 denotes the period from the time the corresponding VM was backed up until the next time when it will be backed up once again.

The backup protection period 11103 denotes the period during which the backed up information will be stored. In FIG. 11, the VM1 protection period is seven days, and this denotes that the backed up VM1 information will be protected in the copy-destination logical volume of the storage system 300 for seven days.

The start time 11104 denotes the time at which a backup will start. The end time 11105 denotes the time at which a backup will end.

### (1-11) Copy-Pair Management Information

FIG. 12 is an example of a block diagram of the copy-pair management information 1210 stored in the storage system 300. The process for creating the copy-pair management information 1210 will be explained using FIG. 26, which will be described further below. The copy-pair management information 1210 comprises a copy group ID 12100, a pair ID 12101, a volume ID 12102, copy status information 12103, a copy-targeted storage ID 12104, a copy-targeted volume ID 12105, and a copy type 12106.

The copy group ID 12100 is the identifier of the copy group to which the copy pair identified by the pair ID 12101 belongs. The storage system 300 manages a copy group comprising one or more copy pairs. For this reason, the management computer 100 is able to specify a copy group, and issue instructions in the lump for a copy pair included in the group to temporarily suspend, resume or delete the operation of either a local copy or a remote copy.

The pair ID 12101 is the identifier of the copy pair that is configured from the logical volume identified by the volume ID 12102 and the logical volume identified by the copy-targeted volume ID 12105. Specifically, the pair ID 11303 of the copy configuration information 1103 explained using FIG. 5 is registered.

The volume ID 12102 is the identifier of the logical volume provided by the storage system 300 stored in this copy-pair management information 1210.

The copy status information 12103 shows the current status of the copy to the logical volume identified by the volume ID 12102. Specifically, the copy status information 12103 denotes that the logical volume identified by the volume ID 12102 is either “copying”, “temporarily suspended” or “abnormal”.

The copy-targeted storage ID 12104 is the identifier of the storage system 300 that provides the logical volume that will become the copy pair together with the logical volume identified by the volume ID 12102. That is, the secondary storage system 300 identifier is stored in the copy-targeted storage ID 12104.

The copy-targeted volume ID 12105 is the identifier of the logical volume that will become the copy pair together with the logical volume identified by the volume ID 12102. That is, the identifier of the secondary volume, which constitutes the copy destination of the data stored in the logical volume identified by the volume ID 12102, is stored in the copy-targeted volume ID 12105.

The copy type 12106 is the type of copy to be executed by the copy pair identified by the pair ID 12101. Specifically, either of “local copy” or “remote copy” is stored in the copy type 12106. “Local copy” is stored in the copy type 12106 column of this embodiment.

### (1-12) Volume Management Information

FIG. 13 is a block diagram of the volume management information 1250 stored in the storage system 300 of the first embodiment of the present invention.

The volume management information 1250 comprises a volume ID 12501, volume status information 12502, a capacity 12503, a copy-pair ID 12504, and a copy group ID 12505.

The volume ID 12501 is the identifier of the logical volume provided by the storage system 300 stored in this volume management information 1250.

The volume status information 12502 shows the current status of the logical volume identified by the volume ID 12501. Specifically, at least one of “primary”, “secondary”, “normal”, “abnormal” or “not mounted” is stored in the volume status information 12502. For example, in a case where the logical volume identified by the volume ID 12501 is a primary volume, “primary” is stored in the volume status information 12502. In a case where the logical volume identified by the volume ID 12501 is a secondary volume, “secondary” is stored in the volume status information 12502. In a case where the host computer 200 is able to normally access the logical volume identified by the volume ID 12501, “normal” is stored in the volume status information 12502. In a case where the host computer 200 is not able to normally access the logical volume identified by the volume ID 12501, “abnormal” is stored in the volume status information 12502. For example, when a disk device 1500 malfunctions and a copy fails, “abnormal” is stored in the volume status information 12502.

Further, in a case where data has not been stored in the logical volume identified by the volume ID 12501, “not mounted” is stored in the volume status information 12502.

The capacity 12503 is the capacity of the logical volume identified by the volume ID 12501. The copy-pair ID 12504 is the identifier of the copy pair related to the volume ID 12501. Specifically, the pair ID 11303 of the copy information 1103 explained using FIG. 5 is stored in the copy-pair ID 12504.

The copy group ID 12505 is the identifier of the copy group to which the copy pair recorded in the copy-pair ID 12504 belongs. The copy group ID assigned to the copy information 1103 created each time the management computer 100 issues a copy instruction is stored in the copy group ID 12505 column.

FIG. 16 is a schematic diagram describing an example of an I/O request 7300 of the present invention.

The I/O request 7300 is issued by either the management computer 100 or the host computer 200. The I/O request 7300 comprises a destination 73001, instruction content 73002, a control-targeted volume ID 73003, a group ID 73004, and an option 73005.

The address (IP address, product number) of the storage system 300 that constitutes the destination of the I/O request 7300 is stored in the destination 73001. For example, in a case where either the management computer 100 or the host computer 200 send an I/O request 7300 to the storage system 300, the IP address, which is registered in the storage system ID stored in the storage information 1104 (FIG. 4), is stored in the I/O request destination 73001.

The instruction content 73002 is the contents of the processing being instructed by this I/O request 7300. For example, the instruction content 73002 is a configuration information report, a control instruction of the local copy function, or a data access instruction. Specifically, the instruction content 73002 is a write request, a read request, or a copy control instruction. Furthermore, the copy control instruction is a request such as start remote copy, temporarily suspend remote copy, resume remote copy, delete remote copy, start local copy, temporarily suspend local copy, resume local copy, delete local copy, list local copies, or report configuration information.

The control-targeted volume ID 73003 denotes the identifier of the target logical volume to be processed by the storage system 300 based on the instruction content of the I/O request 7300. That is, the storage system 300 implements the processing of the instruction content 73002 for the control-targeted volume ID 73003 included in the received I/O request 7300.

The group ID 73004 is the identifier of the copy group that constitutes the target of the processing in accordance with the I/O request 7300. The copy group ID 11300, which is provided in the copy configuration information 1103 created each time the management computer 100 issue a copy instruction, is stored in the group ID 73004.

The option 73005 stores copy configuration information, option information that supplements this I/O request 7300, and write-requested data in accordance with this I/O request. Furthermore, the copy configuration information comprises a copy type, a copy-destination storage ID, a copy-destination logical volume ID, a copy-source storage ID and a copy-source logical volume ID.

### (1-13) Operation of the First Embodiment

A VM backup operation may be broadly divided into the following four operations. That is, a discovery operation, a schedule definition operation, a backup operation, and a restore operation. These respective operations will be explained hereinbelow.

### (1-13-1) Discovery Operation

The discovery operation is processing that the management computer 100 executes in accordance with a management program 1102 instruction, and detects equipment such as the storage system 300 and host computer 200, and acquires the configuration information of the detected equipment. A storage system 300 discovery will be called a storage discovery here, and a host computer 200 discovery will be called a host discovery.

FIG. 17 is an example of the flow of processing of a storage discovery in accordance with the management computer 100.

First, the management computer 100 specifies a range to be searched by the discovery, for example, IP addresses (Step 5000). For example, the management computer 100 receives an input from the user of the values 192.168.1.0 through 192.168.1.255, and the management computer specifies the detection range based on the inputted values.

Next, the management computer 100 creates an I/O request 7300 that commands a configuration information report be made to the storage system 300, selects any of the addresses in the discovery detection range specified in Step 5000 and makes this address the destination, and issues this configuration information report request (Step 5010).

Next, the management computer 100, upon receiving an I/O request response from the storage system 300, analyzes this I/O request response (Step 5020). In a case where the result of analysis is a normal response (Step 5030: Yes), that is, in a case where this I/O request-destination storage system 300 references the volume management information 1250 (FIG. 13) and reports the configuration information of this storage system to the management computer 100, the management computer 100 determines that the storage system 300 exists in the destination of this I/O request, and creates the storage information 1104 (FIG. 4) (Step 5040). At this point, the management computer 100 receives from the storage system 300 information that is included in the volume management information 1250, and creates the storage information 1104 based on the response from the storage system 300.

In a case where the response with respect to the configuration information report I/O request sent from the management computer 100 to the storage system 300 is not a normal response (Step 5030: No), the management computer 100 moves to Step 5060. A case in which the response is not a normal response here signifies, for example, that the I/O request-destination storage system 300 does not exist.

Next, in Step 5060, the management computer 100 determines whether or not the processing of Step 5010 through Step 5040 has ended for all the addresses in the detection range specified in Step 5000 (Step 5060).

In a case where the result of the determination in Step 5060 is that the processing has not ended (Step 5060: No), the management computer 100 changes the I/O request destination address to a different address from the address selected in Step 5010 from among the addresses of the detection range specified in Step 5000, and returns to Step 5010 (Step 5070).

In a case where the management computer 100 determines in Step 5070 that the processing of Step 5010 through Step 5060 has ended for all the addresses of the detection range specified in Step 5000 (Step 5060: Yes), the management computer 100 displays the storage information 1104 created in Step 5040 on the management computer as the storage system information detection results of the discovery operation (Step 5080), and ends the storage discovery.

FIG. 18 is an example of the flow of processing of a host discovery in accordance with the management computer 100.

First, the management computer 100 specifies a range to be searched in the discovery using IP addresses. For example, the management computer 100 receives an input from the user of the values 192.168.2.0 through 192.168.2.255, and the management computer specifies the detection range based on the inputted values (Step 5100).

Next, the management computer 100 creates a configuration information report request for the host computer 200, selects any of the addresses in the discovery detection range specified in Step 5100 and makes this address the destination, and issues this host computer 200 configuration information report request (Step 5110).

Next, the management computer 100, upon receiving a request response from the host computer 200, analyzes this request response (Step 5120). In a case where the result of analysis is a normal response (Step 5130: Yes), the management computer 100 determines that the host computer 200 exists at the destination of this request, and creates the host information 1108 (Step 5140). At this point, the management computer 100 creates the host information 1108 by registering the host ID 11801, the server information 11802 and the volume ID 11803, which are included in the response from the host computer 200.

In a case where the response with respect to the configuration information report I/O request sent from the management computer 100 to the host computer 200 is not a normal response (Step 5130: No), the management computer 100 moves to Step 5160. A case in which the response is not a normal response here signifies, for example, that the I/O request-destination host computer 200 does not exist.

Next, the management computer 100 issues a VM-related configuration information report request to the virtualization program 212 on the host computer (Step 5145). In addition to the configuration information report, instructions such as acquire snapshot and so forth may also be issued to the virtualization program 212 on the host computer 200 at this point. As a result of the above-mentioned configuration information report request, the management computer 100 obtains from the host computer that received this request a list of the virtual volume ID, volume pool ID and logical volumes registered in the volume pool, which are managed by this host computer. Accordingly, the management computer 100 respectively registers the obtained results in the virtual volume ID 11603 and volume pool ID 11605 of the VM information 1106, and the volume pool ID 11901 and volume ID 11903 of the volume pool information 1109 (Step 5150). In addition, the management computer 100 sets the utilization status 11404 in the storage information 1104 to “in use” for the volume ID that is the same as the logical volume registered in the volume pool information 1109.

Next, in Step 5160, the management computer 100 determines whether or not the processing of Step 5110 through Step 5150 has ended for all the addresses in the detection range specified in Step 5100 (Step 5160), and in a case where the result of the determination in Step 5160 is that the processing has not ended (Step 5160: No), the management computer 100 changes the I/O request destination address to a different address from the address selected in Step 5110 from among the addresses of the detection range specified in Step 5100, and returns to Step 5110 (Step 5170).

In a case where the management computer 100 determines in Step 5170 that the processing of Step 5110 through Step 5150 has ended for all the addresses of the detection range specified in Step 5100 (Step 5160: Yes), the management computer 100 displays the host information 1108 created in Step 5140 and the VM information 1106 and volume pool information 1109 created in Step 5150 on the management computer as the host computer information detection results of the discovery operation (Step 5180), and ends the host discovery.

### (1-13-2) Schedule Definition Operation

The schedule definition operation is processing for defining a management computer 100-implemented backup schedule in accordance with a management program 1102 instruction of the management computer 100.

FIG. 19 is an example of the flow of processing of the schedule definition operation in accordance with the management computer 100.

First, the management computer 100 specifies the backup-targeted VM. The backup-targeted VM is all the VM registered in the VM ID 11602 column of the VM information 1106 created in the host discovery (FIG. 18). The management computer 100 selects an arbitrary VM for this list of all the VM based on input from the user (Step 5200).

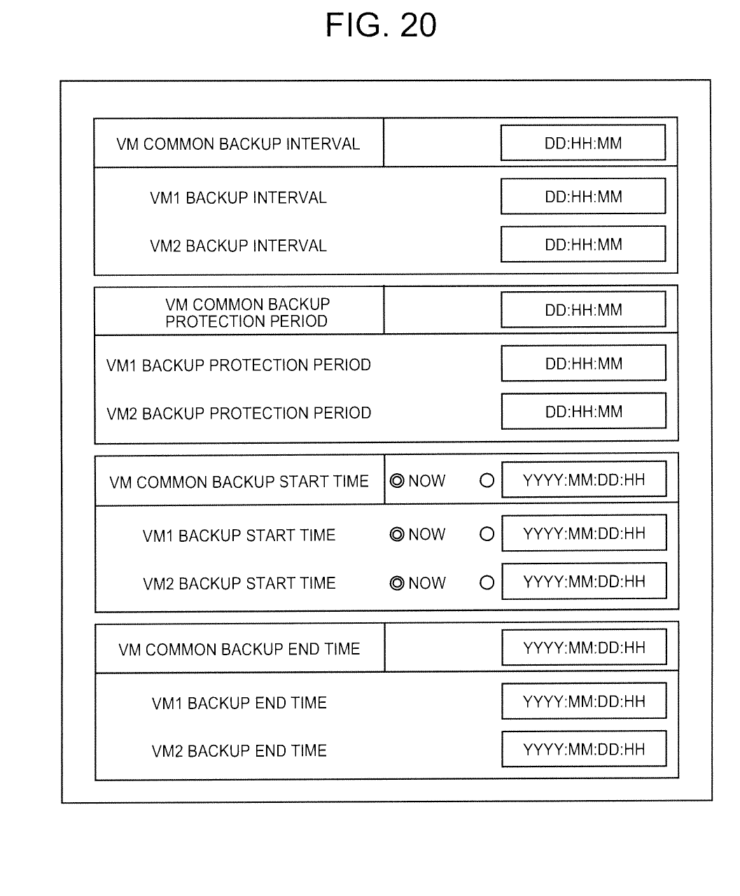

Next, the management computer 100 specifies the backup schedule information (Step 5210). For example, the backup schedule input screen shown in FIG. 20 is displayed on the screen of the management computer 100, and upon receiving time input from the user, the management computer 100 specifies the schedule information based on the inputted time. The user is able to input the backup interval, the backup protection period, and the backup start time and end time on the backup schedule input screen of FIG. 20. In addition, it is also possible to define either items held in common by all the specified VM or individual items of each VM with respect to each of the backup interval, the backup protection period, and the backup start time and end time on the backup schedule input screen of FIG. 20. That is, if specifying a value in an item that is common to all the VM, the same value will be specified for all the VM specified in Step 5200. Conversely, it is also possible to specify an independent value as the backup interval and so forth for each specified VM.

Next, the management computer 100 creates the backup definition information 1110 (FIG. 11) from the information specified on the backup schedule input screen of FIG. 20. Specifically, the specified VM is stored in the VM ID 11101 column, the backup interval is stored in the backup interval 11102 column, the protection period is stored in the protection period 11103 column, and the start and end times are respectively stored in the start time 11104 and the end time 11105 columns (Step 5220).

Next, the management computer 100 computes the number of VM backup generations (Step 5230). The VM backup generations are the number of pieces of VM information backed up at respectively different times, and matches with the number of copy groups. For example, a third-generation backup denotes that a maximum of three pieces of backup information have been acquired at different times for a certain VM. Specifically, the management computer 100 references the backup definition information 1110 created in Step 5220, computes the 1/(backup interval) for each VM ID, and computes the number of backup acquisitions per unit of time. Next, the management computer 100 adds the number of backup acquisitions per unit of time (called value A) for all specified VM, and next calculates the average (called the B value) of the backup protection periods for all the user-specified VM, and finally implements A*B to obtain the number of VM backup generations. For example, the number of generations for two VM, i.e. VM1 and VM2, will be considered in a case where VM1 has a backup interval of two hours and a backup protection period of 24 hours, and VM2 has a backup interval of three hours and a backup protection period of 36 hours. Since A=(½+⅓) and B=(24+36)/2, the number of backup generations becomes A*B=25. Actually, this number of backup generations is an average value, giving rise to the likelihood that an error could occur, resulting in insufficient locations to stores the backup information. Therefore, this average value may be handled as the number of backup generations plus 2 or 3 generations.

Next, the management computer 100 creates a copy definition (Step 5240). The copy definition create will be explained in detail using the below-described FIG. 21.

Next, the management computer 100 references the storage information 1104, selects the storage system ID 11401 and volume ID 11403 for which the utilization status 11404 of this information is “unused”, and respectively registers the selected storage system ID and volume ID in the secondary storage system ID 11306 and secondary volume ID 11307 columns of the copy configuration information (Step 5320). The management computer 100 determines the copy-destination logical volume like this.

Next, the management computer 100 determines the copy information of the copy configuration information 1103. Specifically, the management computer 100, for example, uses the number of backup generations calculated in Step 5230 of FIG. 19 to determine the copy type. That is, the management computer 100 confirms that this number of generations does not exceed the maximum number of generations of the storage system copy function. In a case where this number of generations does not exceed the maximum number of generations, the management computer 100 selects this copy type. The management computer may also select a predetermined copy type rather than the above. The management computer 100 registers the selected copy type in the copy information 11301 column of the copy configuration information 1103, and ends the creation of the copy configuration information 1103 (Step 5330).

The management computer 100 repeats Steps 5310 through 5330 for the number of backup generations created in Step 5230 of FIG. 19, and creates the copy configuration information 1103 so that the copy group ID of the copy configuration information 1103 will differ. When the creation of the copy configuration information 1103 for the number of backup generations has ended (Step 5330: Yes), the management computer 100 creates the copy group utilization information 1101 (FIG. 10). The copy group utilization information 1101 is configured from the copy group ID 11011, the validation flag 11012, and the expiration date 11013. The number of entries of this information is used to create the number of backup generations calculated in Step 5230. In creating the copy group utilization information 1101 here, the management computer 100 sets “invalid” in all the validation flag 11012 fields, and registers the expiration data as NULL. In accordance with the above, the management computer 100 ends the detailed flow of processing for the copy definition create (Step 5240 of FIG. 19).

At this point, the explanation will once again return to the flow of processing for the schedule definition operation of FIG. 19. The management computer 100 reads out the VM ID 11101 and start time 11104 registered in the backup definition information 1110 (FIG. 11), and registers same in the scheduler (not shown in the drawing) provided by the management computer 100 so that the arrival of the above-mentioned start time invokes a backup operation of the VM denoted by the VM ID. When the start time 11104 specified by the management computer 100 arrives, the management computer 100 scheduler executes the content registered in the scheduler (assumed here to be the invocation of the below-described backup operation (FIG. 22)) (Step 5260).

Next, the processing flow for the copy definition create of FIG. 21 will be described in detail. First, the management computer 100 creates copy configuration information 1103 (FIG. 5) for use by the storage system 300 in the copy function (Steps 5310, 5320, 5330). Specifically, the management computer 100 references the VM information 1106 (FIG. 6) to determine the copy-targeted copy-source logical volume, acquires the volume pool ID 11605 of the VM ID denoting the VM that is the copy target, and, based on this volume pool ID 11605, acquires the storage ID 11902 and volume ID 11903 corresponding to this volume pool ID from the volume pool information 1109 (FIG. 8).

Next, the management computer 100 repeats Steps 5310, 5320 and 5330 until the number of backup generations has been created (Step 5340).

Next, the management computer 100 respectively registers this storage ID and volume ID in the primary storage system ID 11304 and primary volume ID 11305 columns of the copy configuration information 1103 (Step 5350). The management computer 100 determines the copy-source logical volume like this.

### (1-13-3) Backup Operation

The backup operation is processing for acquiring a VM backup implemented by the management computer 100 in accordance with an instruction of the management program 1102.

FIG. 22 is the flow of processing of the VM backup operation in accordance with the management computer 100.

First, the VM backup operation by the management computer 100 starts upon being invoked by the management computer 100 scheduler implemented in Step 5260 of FIG. 19.

Specifically, the management computer 100 acquires the ID of the VM that constitutes the backup target (called the target VM) and the instruction content from the scheduler. Next, in a case where the instruction content is a backup acquisition instruction, the management computer 100 references the copy group utilization information 1101 (FIG. 10), and searches this information for a validation flag 11012 that is “invalid” (Step 5410). In a case where none of the validation flags of the copy group utilization information 1101 is “invalid” (Step 5410: No), the management computer 100 also references the expiration dates 11013 of the copy group utilization information 1101, and compares the current time managed by the management computer 100 against the expiration dates (Step 5420). In a case where there is no expiration date 11013 in the copy group utilization information 1101 that is before the current time (Step 5420: No), the management computer 100 implements error processing (Step 5430). The error process, for example, is a method by which the management computer 100 notifies the user that an error has occurred by displaying a message on the display screen of the management computer 100.

In a case where an “invalid” validation flag exist in the copy group utilization information 1101 (Step 5410: Yes), the management computer 100 arbitrarily selects one of the copy groups in which an “invalid” flag has been set. Further, in a case where there is an expiration date 11013 in the copy group utilization information 1101 that is before the current time (Step 5420: Yes), the management computer 100 registers “invalid” in the validation flag 11012 of the copy group for which the expiration date has elapsed in the copy group utilization information 1101, and, in addition, arbitrarily selects one of the copy groups in which an “invalid” flag has been set. The ID 11011 of the copy group selected by the management computer 100 here will be called the “utilization copy group ID”. Furthermore, the management computer 100 issues a target VM snapshot acquisition request to the host computer 200 (Step 5440). Consequently, the host computer 200 acquires a snapshot of the specified target VM using the virtualization program 212 on this computer.

The management computer 100 obtains a response to this snapshot acquisition request from the host computer 200 (Step 5445). The management computer 100 analyzes this response, and in a case where the snapshot acquisition was successful (Step 5445: Yes), acquires from this snapshot acquisition request response the snapshot ID that will be used when restoring the snapshot.

Next, the management computer 100 creates an I/O request for the storage system 300. Specifically, the management computer 100 creates the I/O request by setting the utilization copy group ID in the copy group ID 11300 and specifying the local copy control instruction 11301 as the instruction content, and issues the create I/O request to the storage system 300 (Step 5450).

The management computer 100 obtains this I/O request response from the storage system 300. The management computer 100 analyzes this response, and in a case where this I/O request response is successful (Step 5455: Yes), that is, when the local copy has been completed, the management computer 100 deletes the target VM snapshot file created in the past. Specifically, the management computer 100 references the latest residual VM information (11503, 11504, 11505) of the backup catalog information 1105 (FIG. 9), and acquires the identifier of the target VM snapshot. Next, the management computer 100 specifies this snapshot identifier, and issues a snapshot file deletion request to the host computer (Step 5457).

The management computer 100 implements the process for creating the backup catalog (Step 5460). Specifically, as the process for creating the backup catalog, the management computer 100 references the latest residual VM information of the backup catalog information 1105, next adds a new entry to this backup catalog information 1105, and replaces the residual VM information of this entry with the latest residual VM information (Step 5460). However, in a case where the backup catalog information 1105 is created anew, all of the backup-targeted VM are recorded in the residual VM information, and the residual VM information registers NULL. For example, in a case where the user selected VM1 and VM2 as the backup targets, the two sub-columns of VM1 and VM2 are created in the residual VM information of the backup catalog information 1105.

Next, the management computer 100 registers the management computer-managed current time in the time 11501 column of the new entry of the backup catalog information 1105 created anew in Step 5460, registers the ID of the target VM obtained from the scheduler in the backup target 11502 column, and registers the utilization copy group ID obtained from the scheduler in the copy group ID 11506 column. Then, the management computer 100 stores the snapshot file creation time acquired in accordance with the snapshot acquisition instruction of Step 5440 and the snapshot identifier in the residual VM information of this target VM. In addition, the management computer 100 sets the validation flag 11012 for the copy group ID of the copy group utilization information 1101 (FIG. 10) that coincides with the utilization copy group to “valid”. Next, the management computer 100 reads out the target VM backup interval 11102 from the backup definition information 1110, and sets a value arrived at by adding this backup interval 11102 and the current time 11501 in the start time of the scheduler, and performs a setting such that the target VM invokes this backup operation at the specified start time (Step 5470).

In a case where either the snapshot acquisition was not successful in Step 5445 (Step 5445: No), or this I/O request response was not obtained from the storage system 300 in Step 5455 (Step 5455: No), the management computer 100 implements error processing (Step 5430).

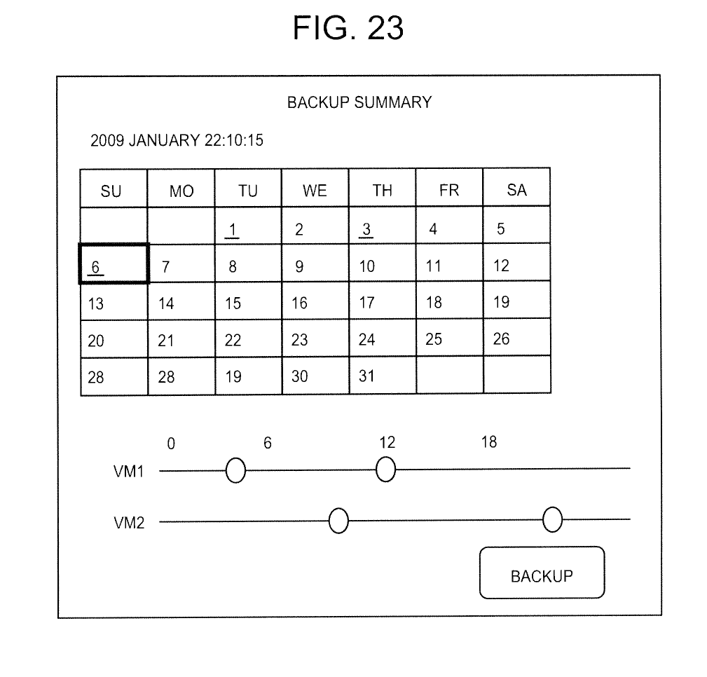

The management computer 100 may display the results of this VM backup on a screen at this point. FIG. 23 shows an example of the backup result screen. The screen's calendar shows when backups were performed during the current month by underlining and highlighting the dates on which backups were acquired. The number lines show the times at which backups were performed during a single day, and clicking on the highlighted dates in the calendar (1^{st}, 3^{rd}, 6^{th}) displays the results of backup acquisitions for the clicked date on the number lines. The “circles” on the number lines denote the times at which backups were acquired. Clicking on one of the above-mentioned “circles” causes the management computer 100 to implement a restore operation. The restore operation will be explained in 1-13-4 below. Further, if the BACKUP button at the bottom of the screen is clicked by the user, the management computer 100 backs up all the backup-targeted VM at the prescribed backup times (Processing flow shown in FIG. 22).

Furthermore, a method other than this may be used to display the backup acquisition dates.

### (1-13-4) Restore Operation

The restore operation is processing implemented by the management computer 100 for restoring a backed-up VM in accordance with an instruction of the management program 1102 (FIG. 2) inside the management computer 100.

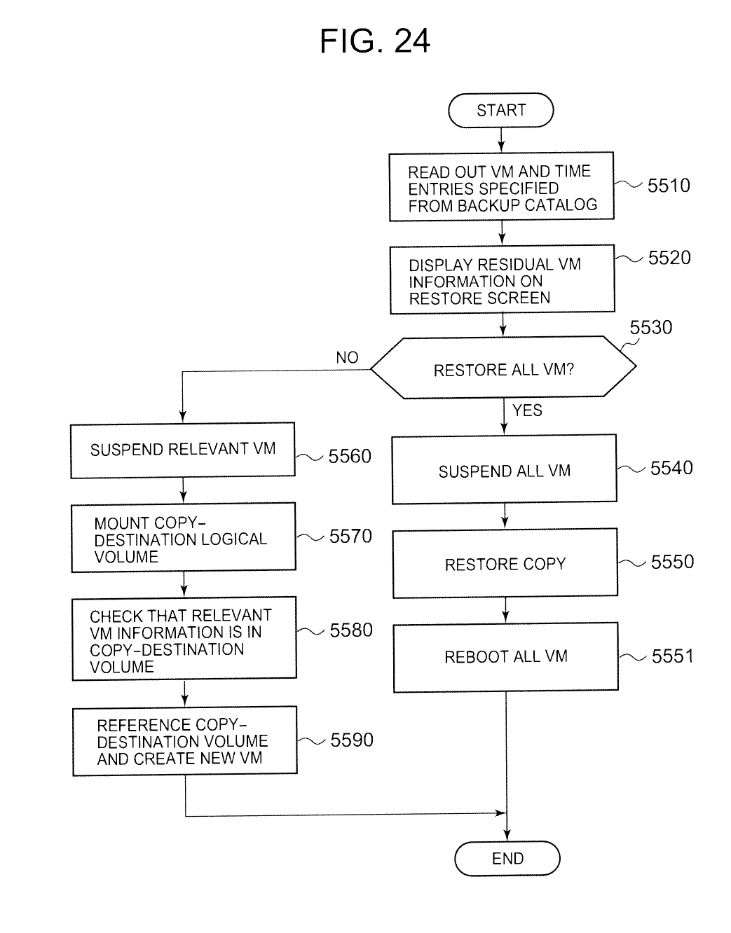

FIG. 24 is an example of the flow of processing of the restore operation in accordance with the management computer 100.

First, the management computer 100 references the backup catalog information 1105 (FIG. 9) to carry out a restore for the user-specified VM, and based on the specified restore-targeted VM and the restore time thereof, acquires the relevant entries of the backup catalog information 1105 corresponding to this information (Step 5510).

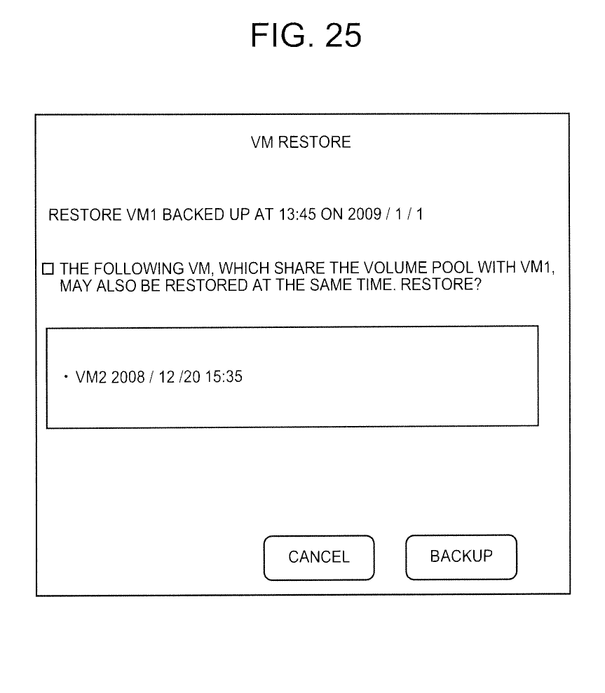

Next, the management computer 100 fetches the residual VM information inside the relevant entry of the backup catalog information 1105, and displays the information of the VM other than the restore-targeted VM on the screen (Step 5520). FIG. 25 shows an example of the screen display. In FIG. 25, VM1 is the restore target, and the other VM (VM2) is displayed as a VM that is capable of being restored at the same time.

Next, in a case where all the VM will be restored (Step 5530: Yes), the management computer 100 proceeds to Step 5540, and in a case where only the specified VM will be restored (Step 5530: No), the management computer 100 moves to Step 5560. In the example of FIG. 25, this is determined by the presence or absence of a check in the check box (The following VM, which share the volume pool with VM1, may also be restored at the same time. Restore?)

In a case where all the VM will be restored (Step 5530: Yes), the management computer 100 issues the host computer 200 an instruction to suspend all backup-targeted VM (Step 5540).

Next, the management computer 100 issues the storage system 300 an I/O request that specifies local copy restore as the instruction content for the copy group of the copy group ID 11506 in the relevant entry of the backup catalog information 1105 (Step 5550). Upon receiving this I/O request, the storage system 300 implements a copy that reverses the relationship of the copy source and copy destination, and overwrites the information of the copy-destination logical volume in the copy-source logical volume.

Next, the management computer 100 instructs the host computer 200 to resume all VM (Step 5555). At this point in time, because the data referenced by the host computer 200 has been replaced with the backed-up information, the backed-up VM of a previous time is re-booted.

Conversely, in a case where all the VM are not to be restored (Step 5530: No), the management computer 100 issues a request to the host computer 200 to suspend only the restore-targeted VM (Step 5560).

Next, the management computer 100 references the copy configuration information 1103 of the relevant copy group ID 11506 from the copy group ID 11506 in the relevant entry of the backup catalog information 1105, acquires the copy-destination storage system (secondary storage system ID 11306) and the copy-destination logical volume (secondary volume ID 11307), and instructs the host computer 200 to change this copy-destination logical volume to accessible status (mount processing) (Step 5570).

Next, the management computer 100 instructs the host computer 200 to check the content of the copy-destination logical volume mounted in Step 5570, and to confirm the presence of a snapshot file of the restore-targeted VM (Step 5580).

Finally, the management computer 100 instructs the host computer 200 to create a new VM, and to reference the snapshot file of the restore-targeted VM from the above-mentioned copy-destination logical volume (Step 5590). In addition, the management computer 100 may also issue an instruction to the host computer 200 to migrate the VM information of this copy-destination logical volume to the copy-source logical volume. Migrating this information to the copy-source logical volume makes it possible to consolidate the VM information in the VM data volume of up to this time, thereby enabling the VM to continue processing.

### (1-14) Storage System Operation

FIG. 26 is an example of the flow of copy processing executed by the storage system 300 of the first embodiment of the present invention.

The processor 1310 of the storage system 300, upon receiving an I/O request 7300 (FIG. 16) instructing the start of a local copy, starts the copy process. The local copy process will be explained here.

The storage system 300 processor 1310 creates the copy-pair management information 1210 (FIG. 12) based on clipped copy configuration information (FIG. 5) (Step 6010).

Specifically, the storage system 300 processor 1310 stores “copying” in the copy status information 12103 column of the copy-pair management information 1210. Next, the storage system 300 processor 1310 stores the copy-source logical volume ID described in the I/O request in the volume ID 12102 column of the copy-pair management information 1210 as the copy-source logical volume.

Next, the storage system 300 processor 1310 stores the copy-destination storage ID included in the copy management information clipped from the I/O request in the copy-targeted storage ID 12104 column of the copy-pair management information 1210. Next, the storage system 300 processor 1310 stores the copy-destination logical volume ID included in the copy management information (FIG. 4) clipped from the I/O request in the copy-targeted volume ID 12105 column of the copy-pair management information 1210.

Next, the storage system 300 processor 1310 stores a non-overlapping value in the pair ID 12101 column of the copy-pair management information 1210. Next, the storage system 300 processor 1310 stores the copy group ID included in the I/O request in the copy group ID 12100 column of the copy-pair management information 1210. Next, the storage system 300 processor 1310 stores the copy type information included in the clipped copy management information in the copy type 12106 column of the copy-pair management information 1210. “Local copy” is stored in the copy type 12106 column here.

Next, the storage system 300 processor 1310 reads out data from the disk device 1500 identified by the volume ID 12102 of the copy-pair management information 1210. Then, the storage system 300 processor 1310 stores the read-out data in the cache memory 1100 (Step 6030). Next, the storage system 300 processor 1310 reads the data out from the cache memory and also writes the read-out data from the cache memory to the logical volume identified by the copy-targeted volume ID 12105 of the copy-pair management information 1210 (Step 6060).

The storage system 300 stores all of the data in the copy-source volume in the copy-destination volume by repeatedly executing the processing from Step 6030 to Step 6060.

Then, the storage system 300 ends the local copy process. When the local copy ends, the storage system 300 stores “copy status” in the copy status information 12103 column of the copy-pair management information 1210.

According to the first embodiment of the present invention hereinabove, the management computer 100 is able to acquire a snapshot of arbitrary VM running on one or more host computers 200 that share the logical volumes on the storage system, and to perform a backup using the copy function of the storage system. In addition, in a case where all the backed up VM are to be restored, the management computer 100 is able to restore all the VM by implementing a copy (a local copy restore) in the reverse direction, returning the backed-up content to the logical volume used by the host computer and rebooting the VM. Further, in a case where only an arbitrary VM is to be restored, the management computer 100 is able to restore the arbitrary backed-up VM without affecting the other VM by instructing the host computer 200 to mount the copy-destination logical volume in which the backed-up information is stored to the storage system, creating a new VM and setting the data storage of the VM in this copy-destination logical volume.

### Embodiment 2

Next, a second embodiment of the present invention will be explained. According to the second embodiment, it is possible to enhance the capacity efficiency of backup data stored in the storage system. This is able to be realized by making the timing of an arbitrary VM snapshot file acquisition by the host computer 200 asynchronous to the timing at which the storage system 300 implements the copy function for a logical volume.

### (2-1) Overview of Second Embodiment

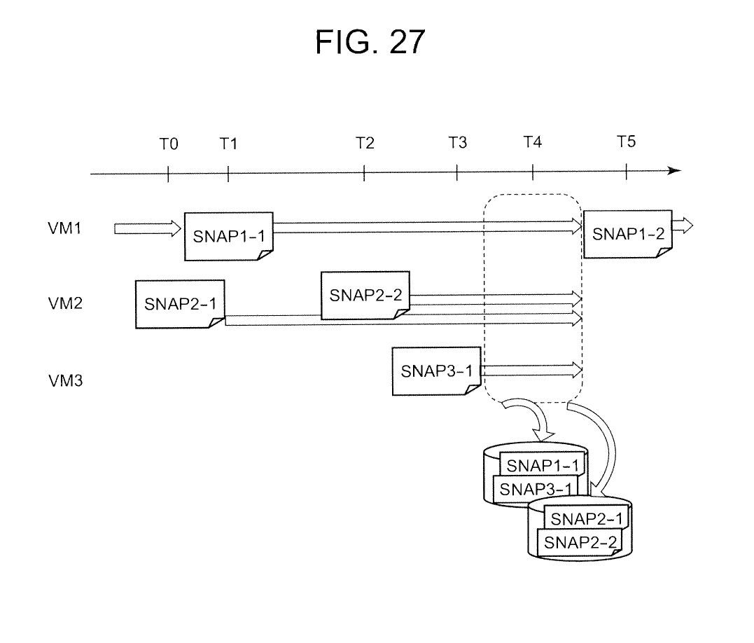

The enhancement of backup data capacity efficiency will be explained using the schematic VM backup operation diagram of FIG. 27. The backups of three VM (VM1, VM2, VM3) will be considered. In the second embodiment, the computer system first uses the storage system-based logical volume copy function after having acquired a certain portion of the snapshot files of VM1, VM2 and VM3. Subsequent to using the copy function, this computer system deletes all the snapshot files. In accordance with the above-mentioned steps, it is possible to eliminate snapshot file overlap among a plurality of secondary logical volumes, enabling the backup capacity to be made more efficient.

### (2-2) System Configuration

FIG. 29 shows the configuration of the computer systems of the second embodiment of the present invention. In the configuration of the computer system of the second embodiment, the information stored in the memory 110 of the management computer 100 differs from that of the first embodiment. Specifically, RPO information 1111 is added.

### (2-3) Operation of Second Embodiment

Next, the operation of the second embodiment will be explained in terms of the differences with the operation of the first embodiment. Specifically, there are changes to the schedule definition and backup operations, and a storage system-based copy processing operation is added.

### (2-3-1) Schedule Definition Operation

First, in the schedule definition operation (FIG. 19) in accordance with the management computer 100, the processing content of the step (Step 5210)for inputting the interval for implementing the storage system copy function, and of the step (Step 5260) for registering a backup task in the scheduler differ.

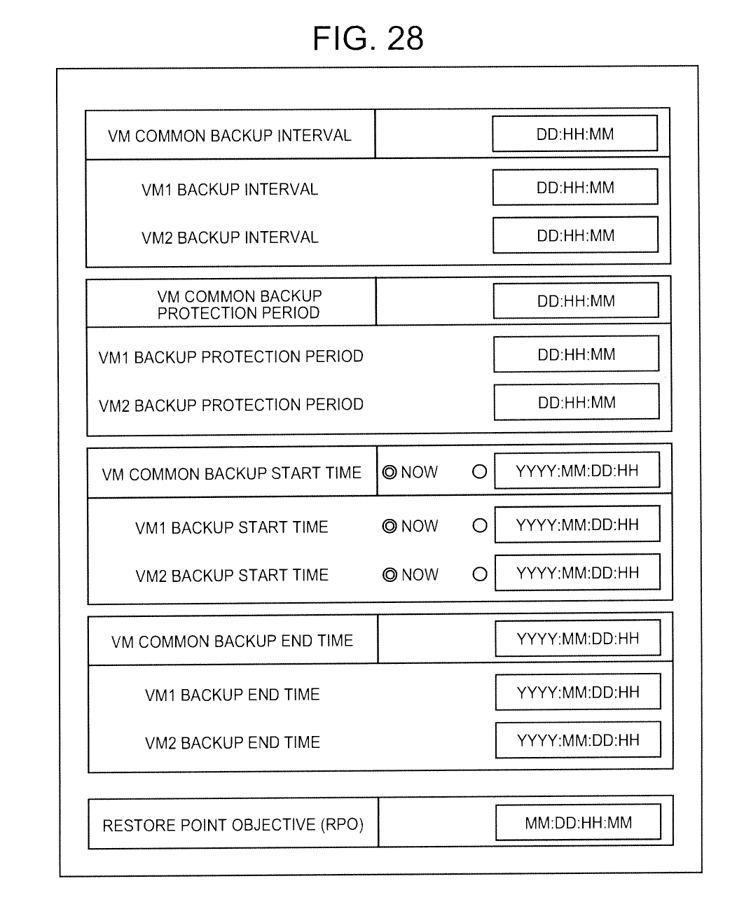

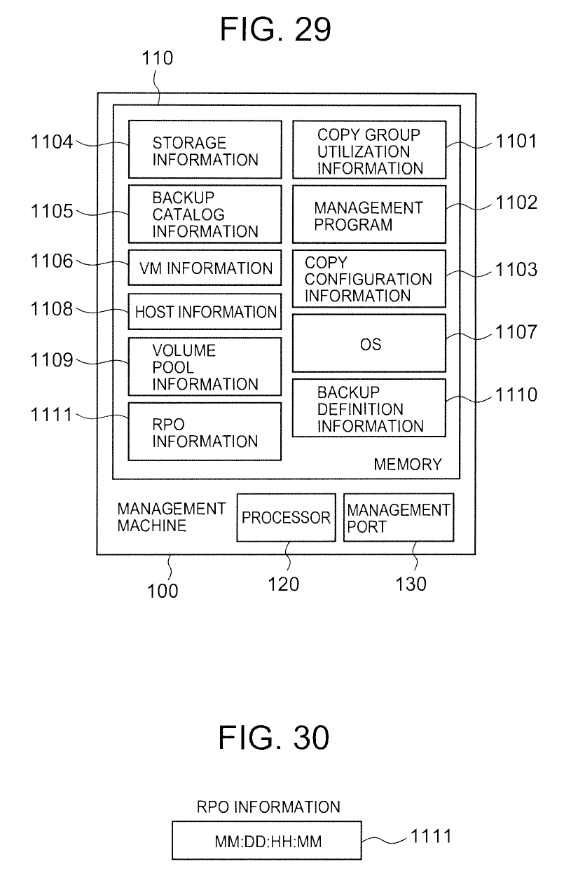

In Step 5210, a “restore point objective” input area is added at the bottom of the input screen of FIG. 20 as in the backup schedule input screen of FIG. 28. A value obtained via this input area is stored in the RPO information 1111. In Step 5260, the management computer 100 registers processing for two operations in the scheduler (not shown in the drawing) provided by the management computer 100. That is, a VM backup operation and the below-described storage system-based copy process. Consequently, it is possible to invoke a storage system-based copy process at a time stored in the RPO information using a scheduler that is independent from the VM backup operation in the above-mentioned scheduler.

### (2-3-2) VM Backup Operation

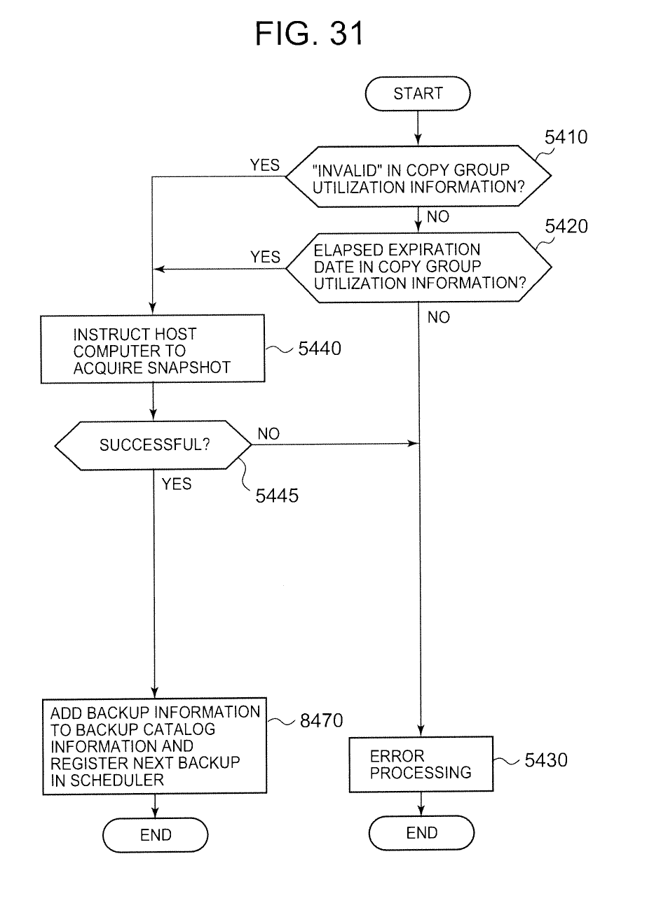

Next, the VM backup operation in accordance with the management computer 100 will be explained using FIG. 31.

In a case where the determination in Step 5445 of FIG. 31 is successful (a case in where the management computer 100 analyzes the snapshot acquisition request response and the snapshot acquisition was successful), the management computer 100 records “ALL” in the backup target 11502 column of the latest entry of the backup catalog information 1105 so that all VM become targets. However, the management computer 100 does not record anything in the relevant entry time 11501 column.

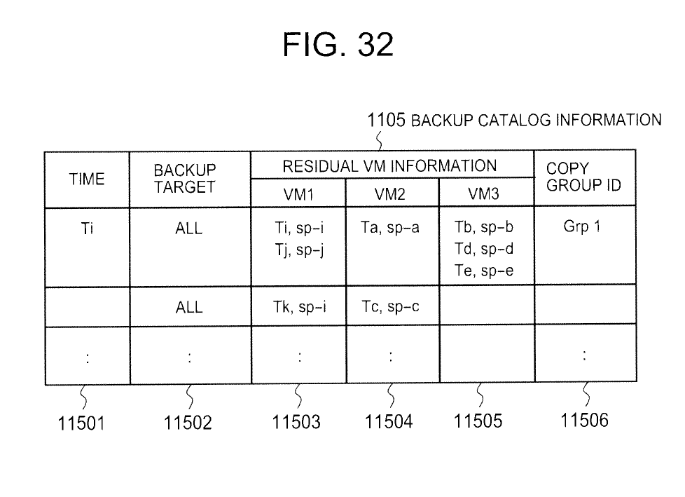

Then, the management computer 100 adds the snapshot file creation time and snapshot identifier acquired in accordance with the snapshot acquisition instruction of Step 5440 to the residual VM information of this target VM. In a case where information has already been recorded in the residual VM information here, the new information is added subsequent to this information as in the backup catalog information of FIG. 32.

Furthermore, unlike the operation of the first embodiment, the management computer 100 reads out the target VM backup interval 11102 from the backup definition information 1110 without updating the copy group utilization information 1101, sets a value achieved by adding the current time 11501 to this backup interval 11102 in the scheduler start time, and performs a setting so that the target VM invokes a backup operation at the specified start time (Step 8470).

### (2-3-3) Storage System-Based Copy Processing Operation

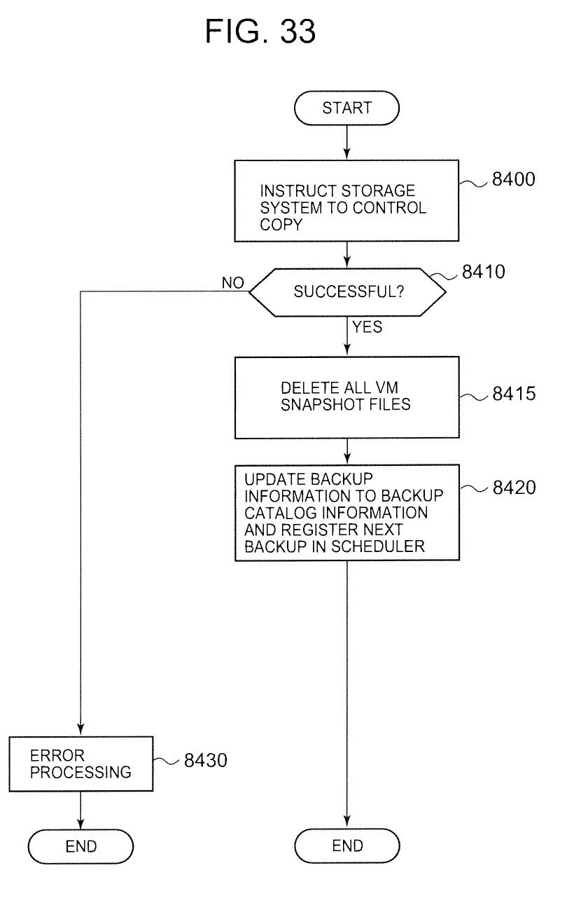

In the second embodiment of the present invention, an operation for the storage system-based copy processing of FIG. 33 is required in addition to the VM backup operation of FIG. 31 by the management computer 100.

First, the management computer 100 creates an I/O request for the storage system 300 when this storage system-based copy processing is invoked by the scheduler of this machine 100. Specifically, the management computer 100 sets the utilization copy group ID in the copy group ID 11300, specifies the local copy control instruction 11301 as the instruction content, creates the I/O request, and issues the created I/O request to the storage system 300 (Step 8400).

The management computer 100 obtains this I/O request response from the storage system 300. The management computer 100 analyzes this I/O request response, and in a case where this I/O request response is successful (Step 8410: Yes), that is, in a case where the local copy has been completed, the management computer 100 deletes all the VM snapshot files created in the past. Specifically, the management computer 100 references the latest residual VM information (11503, 11504, 11505) in the entry that records the time 11501 of the backup catalog information 1105, and acquires the identifiers of all the snapshots registered in the residual VM information. Next, the management computer 100 specifies these snapshot identifiers, and issues a snapshot file delete request to the host computer (Step 8415).

Next, the management computer 100 implements processing for creating a backup catalog. Specifically, the management computer 100, as the processing for backup catalog creation, registers the management computer-managed current time in the time 11501 column of a new entry in which a time 11501 has not been registered in the backup catalog information 1105 (FIG. 32), and registers the utilization copy group ID obtained from the scheduler in the copy group ID 11506 column of the backup catalog information 1105. In addition, the management computer 100 sets “valid” in the validation flag 11012 for the copy group ID of the copy group utilization information 1101 that coincides with the utilization copy group. Next, the management computer 100 performs a setting such that a value, which was attained by adding the value registered in the RPO information 1111 as the backup interval to the current time, is set in the scheduler start time, and this start time invokes the next storage system-based copy process (Step 8420).

In a case where the I/O request response is analyzed in Step 8410, and this I/O request response is unsuccessful (Step 8410: No), the management computer 100 implements error processing (Step 8430).

According to the second embodiment of the present invention above, the management computer 100 is able to perform a secondary logical volume backup with high data capacity efficiency by implementing a snapshot acquisition of arbitrary VM running on one or more host computers 200 that share the logical volumes on the storage system asynchronously to the control of a storage system copy function. In addition, in a case where all the VM inside a backed-up secondary logical volume are to be restored, the management computer 100 is able to restore all the VM by implementing a copy (a local copy restore) in the reverse direction, returning the backed-up content to the logical volume used by the host computer and rebooting the VM. Further, in a case where only an arbitrary VM is to be restored, the management computer 100 is able to restore the arbitrary backed-up VM without affecting the other VM by instructing the host computer 200 to mount the copy-destination logical volume in which the backed-up information is stored to the storage system, and also creating a new VM and setting the data storage of the VM in this copy-destination logical volume.

What is claimed is:

1. A storage system comprising a management computer, a host computer and a storage device, wherein
the host computer provides a first virtual machine and a second virtual machine to the host computer;
the host computer, based on an instruction from the management computer, creates a first snapshot file of the first virtual machine at a first time specified by the management computer, and stores the first snapshot file in a first logical volume of the storage device;
the storage device, based on an instruction from the management computer, replicates in a second logical volume of the storage system the first logical volume;
the management computer manages the first time in association with the first virtual machine snapshot file as the first snapshot file creation time; and
the management computer, in a case where the host computer creates a second snapshot file of the second virtual machine at a second time that is before the first time and stores the second snapshot file in the first logical volume, manages the second snapshot file creation time and a snapshot file of the second virtual machine in association with the first snapshot file creation time and a snapshot file of the first virtual machine.

2. The storage system according to claim 1, wherein the host computer creates the first snapshot file of the first virtual machine at the first time specified by the management computer, and stores the first snapshot file in a second logical volume of a storage system that is externally connected to the storage device.

3. The storage system according to claim 1, wherein the management computer, upon receiving an instruction to restore the first virtual machine at the first time stored in the second logical volume, determines whether only the first virtual machine is to be restored, or the first virtual machine and the second virtual machine are to be restored at the first time.

4. The storage system according to claim 3, wherein, in a case where the management computer has determined that the first virtual machine and the second virtual machine are to be restored at the first time,
(A) the host computer, based on an instruction from the management computer, suspends the first virtual machine and the second virtual machine;
(B) the storage device, based on an instruction from the management computer, writes data stored in the second logical volume back to the first logical volume;
(C) the host computer, based on an instruction from the management computer, boots up the first virtual machine and the second virtual machine, for which data have been written back to the first logical volume; and
(D) the management computer outputs the first snapshot file creation time and the snapshot file of the first virtual machine at the first snapshot file creation time, and the second snapshot file creation time and the snapshot file of the second virtual machine at the snapshot file creation time of the second time.

5. The storage system according to claim 3, wherein the management computer, upon determining that only the first virtual machine is to be restored at the first time, causes a third virtual machine to be provided to the host computer, and
the management computer instructs the host computer to suspend the first virtual machine, to mount the second logical volume of the storage device, and to reference the first virtual machine snapshot file of the second logical volume at the first snapshot file creation time.

6. A management computer which is connected to a host computer that constitutes a first virtual machine and a second virtual machine, and is connected to a storage device having a first logical volume and a second logical volume, wherein
the management computer, in order to restore the first virtual machine at a first time specified by the management computer, instructs the host computer to create a first snapshot file of the first virtual machine at the first time, and to store the first snapshot file in the second logical volume of the storage device;
the management computer instructs the storage device to replicate in the second logical volume of the storage device the first logical volume;
the management computer manages the first time in association with the first virtual machine snapshot file as the first snapshot file time; and
the management computer, in a case where the host computer creates a second snapshot file of the second virtual machine at a second time that is before the first time and stores the second snapshot file in the first logical volume, manages the second snapshot file creation time and the second virtual machine snapshot file in association with the first snapshot file creation time and the first virtual machine snapshot file.

7. The management computer according to claim 6, wherein the management computer instructs the host computer to create a first snapshot file of the first virtual machine at the first time, and to store the first snapshot file in a second logical volume of a storage device that is externally connected to the storage device.

8. A storage system according to claim 6, wherein the management computer, upon receiving an instruction to restore the first virtual machine at the first time stored in the second logical volume, determines whether only the first virtual machine is to be restored, or the first virtual machine and the second virtual machine are to be restored at the first time.

9. The storage system according to claim 8, wherein, in a case where the management computer has determined that the first virtual machine and the second virtual machine are to be restored at the first time,
(A) the management computer instructs the host computer to suspend the first virtual machine and the second virtual machine;
(B) the management computer instructs the storage system to write data stored in the second logical volume back to the first logical volume;
(C) the management computer instructs the host computer to boot up the first virtual machine and the second virtual machine, for which data have been written back to the first logical volume; and
(D) the management computer outputs the first snapshot file creation time and the snapshot file of the first virtual machine at the first snapshot file creation time, and the second snapshot file creation time and the snapshot file of the second virtual machine at the snapshot creation time of the second time.

10. The storage system according to claim 8, wherein, in a case where the management computer has determined that only the first virtual machine is to be restored at the first time,
the management computer instructs the host computer to suspend the first virtual machine, to mount the second logical volume of the storage device, and to reference the first virtual machine snapshot file of the second logical volume at the first snapshot file creation time.

11. A backup management method for a first virtual machine constituting to a host computer in a storage system comprising a management computer, the host computer and a storage device, wherein
the host computer, based on an instruction from the management computer, creates a first snapshot file of a first virtual machine at a first time specified by the management computer, and stores the first snapshot file in a first logical volume of the storage device;
the storage device, based on an instruction from the management computer, replicates in a second logical volume of the storage system the first logical volume;
the management computer manages the first time in association with the first virtual machine snapshot file as the first snapshot file creation time; and
the management computer, in a case where the host computer creates a second snapshot file of a second virtual machine, which is constituted to the host computer, at a second time that is before the first time, and stores the second snapshot file in the first logical volume, manages the second snapshot file creation time and a snapshot file of the second virtual machine in association with the first snapshot file creation time and a snapshot file of the first virtual machine.

12. The backup management method according to claim 11, wherein the host computer creates the first snapshot file of the first virtual machine at the first time specified by the management computer, and stores the first snapshot file in a second logical volume of a storage system that is externally connected to the storage device.

13. The backup management method according to claim 11, wherein the management computer, upon receiving an instruction to restore the first virtual machine at the first time stored in the second logical volume, determines whether only the first virtual machine is to be restored, or the first virtual machine and the second virtual machine are to be restored at the first time.

14. The backup management method according to claim 13, wherein, in a case where the management computer has determined that the first virtual machine and the second virtual machine are to be restored at the first time,
(A) the host computer, based on an instruction from the management computer, suspends the first virtual machine and the second virtual machine;
(B) the storage device, based on an instruction from the management computer, writes data stored in the second logical volume back to the first logical volume;
(C) the host computer, based on an instruction from the management computer, boots up the first virtual machine and the second virtual machine, for which data have been written back to the first logical volume; and
(D) the management computer outputs the first snapshot file creation time and the snapshot file of the first virtual machine at the first snapshot file creation time, and the second snapshot file creation time and the snapshot file of the second virtual machine at the snapshot file creation time of the second time.

15. The backup management method according to claim 13, wherein
the management computer, upon determining that only the first virtual machine is to be restored at the first time, causes a third virtual machine to be provided to the host computer, and
the management computer instructs the host computer to suspend the first virtual machine, to mount the second logical volume of the storage device, and to reference the first virtual machine snapshot file of the second logical volume at the first snapshot file creation time.
